(19) United States
(12) Patent Application Publication
(10) Pub. No.: US 2025/0131719 A1
(43) Pub. Date: Apr. 24, 2025

(54) SENSOR DATA INGESTION AND ANALYSIS FOR PREDICTIVE MODELING AND COMPARISON OR COMMUNAL DATA INPUT

(71) Applicant: Blue 42 Investments, LLC, Bountiful, UT (US)

(72) Inventors: Aaron Rupp, Bountiful, UT (US); Norman Rupp, Lehi, UT (US)

(73) Assignee: Blue 42 Investments, LLC, Bountiful, UT (US)

(21) Appl. No.: 18/932,539

(22) Filed: Oct. 30, 2024

Related U.S. Application Data
(63) Continuation-in-part of application No. 18/773,564, filed on Jul. 15, 2024.
(60) Provisional application No. 63/513,778, filed on Jul. 14, 2023.

(51) Int. Cl. G06V 20/40; G06Q 50/34; G07F 17/32

(52) U.S. Cl. CPC G06V 20/42; G06Q 50/34; G07F 17/3288

(57) ABSTRACT

Systems and methods for synchronous data distribution and ingesting data from numerous sources. A method includes ingesting sensor data captured at a live sporting event and rendering a graphical user interface to provide a depiction of at least a portion of the sensor data as the live sporting event occurs. The method includes receiving a plurality of sports play predictions from a plurality of users and processing the plurality of sports play predictions prior to an upcoming sports play occurring in the live sporting event. The method includes evaluating the plurality of sports play predictions against an actual sports play that occurred in the live sporting event to identify which of the plurality of sports play predictions correctly predicted the actual sports play.

### CROSS-REFERENCE TO RELATED APPLICATIONS

This application is a continuation-in-part of U.S. patent application Ser. No. 18/773,564, filed Jul. 15, 2024, titled “SENSOR DATA INGESTION AND ANALYSIS FOR PREDICTIVE MODELING AND COMPARISON OF COMMUNAL DATA INPUT,” which claims the benefit of U.S. Provisional Patent Application No. 63/513,778, filed Jul. 14, 2023, titled “PREDICTIVE SPORTS GAME AND BETTING APPLICATION,” which is incorporated herein by reference in its entirety, including but not limited to those portions that specifically appear hereinafter, the incorporation by reference being made with the following exception: In the event that any portion of the above-referenced patent applications are inconsistent with this application, this application supersedes the above-reference patent applications.

### TECHNICAL FIELD

The present disclosure relates generally to real-time data assessment and real-time ingestion of data inputs provided by a plurality of independent devices.

### BACKGROUND

Sports teams often utilize sensor data that is captured by specialized sensors in real-time during sports games and practices. Amateur and professional teams, coaches, and fans record and evaluate data and statistics for comparing the performance of teams and individual athletes. Teams, coaches, scouts, agents, and fans also review data, video, and statistics to analyze athletic performance and further appreciate the players' athletic accomplishments. Teams and coaches use data, video, and statistics to evaluate present and potential athletes, and their performances. Teams and coaches may also plan game strategies based upon opponents' athletic abilities and performance data and statistics.

For years, sporting institutions like the National Football League (NFL) have engaged in data collection and analytics of players, plays, and other metrics to drive innovation in player safety, assess potential rule changes, and determine equipment safety standards. The NFL has collected data through video analysis and equipment sensor readings to collect data from every move a player makes on a field. The data collection is used for things like identification of concussion events, reduction of lower extremity injuries, and measurement impact of rule changes. The NFL has additionally used data to run simulations to assess the impacts of player equipment, player fatigue, weather conditions, field conditions, lighting, called plays, rules, and so forth, to assess how those factors impact player safety and performance.

Today, statistics about players are produced in in real time. With artificial intelligence and/or machine learning (AI/ML) algorithms, gathered sensor and video analysis data can be organized and analyzed to produce real-time statistics about what is happening on the field in minutes. The analyzed data can be used in contexts like broadcasting to improve commentary on the game in terms of reporting speed and accuracy.

What is needed are systems, methods, and devices to leverage sensor data collection and real-time statistics analysis to provide an opportunity for coaches, players, and fans to engage with a game in real-time. Further what is needed are systems, methods, and devices to ensure that numerous fans receive sensor data and statistics simultaneously to enable those fans to provide real-time feedback and engage in real-time betting regardless of how the fans are viewing the game.

In view of the foregoing, described herein are systems, methods, and devices for retrieving, assessing, and distributing live telemetry data associated with a sports game. The systems, methods, and devices described herein may be implemented to enable viewers to compete on what play will be called or should be called. This data may be used to show and compare what the collective opinion of participants was against what the actual coach decided.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a schematic block diagram of a system for data ingestion and analysis, wherein the system may be implemented to push real-time sensor data updates to a plurality of user accounts, and further to receive and analyze communal predictions provided by the plurality of user accounts;

FIG. 2 is a schematic block diagram of a system and process flow for distributing data through multiple different media channels;

FIG. 3 is a schematic block diagram of a system and process flow for rendering a graphical user interface of an event prediction platform;

FIG. 4 is a schematic block diagram of a system and process flow for asynchronous data distribution;

FIG. 5 is a schematic block diagram of a system and process flow for asynchronous data distribution;

FIG. 6 is a schematic block diagram of a system and process flow for synchronous data distribution;

FIG. 7 is a schematic block diagram of a system for training an artificial intelligence and/or machine learning algorithm;

FIG. 8 is a schematic flow chart diagram of a method for predicting upcoming sports plays and assigning minimum wager values to the potential upcoming sports plays;

FIG. 9 is a schematic flow chart diagram of a method for ingesting and processing user engagement with a live sporting event;

FIG. 10 is an exemplary graphical user interface rendered by an event prediction server for real-time presentation of sensor data and further for rendering future events;

FIG. 11 is an exemplary graphical user interface rendered by an event prediction server for real-time presentation of sensor data and further for rendering and processing user grouping;

FIG. 12 is an exemplary graphical user interface rendered by an event prediction server for real-time presentation of sensor data and further for rendering and processing user decisions;

FIG. 13A is an exemplary graphical user interface rendered by an event prediction server for real-time presentation of sensor data and further for rendering and processing further user decisions;

FIG. 13B is an exemplary graphical user interface rendered by an event prediction server for real-time presentation of sensor data and further for rendering and processing confirmation of user decisions;

FIG. 14 is an exemplary graphical user interface rendered by an event prediction server for real-time presentation of sensor data and further for rendering and processing results of an analyzed decision;

FIG. 15A is an exemplary graphical user interface rendered by an event prediction server for real-time presentation of sensor data and further for rendering graphical result displays;

FIG. 15B is an exemplary graphical user interface rendered by an event prediction server for real-time presentation of sensor data and further for rendering and processing user rewards;

FIG. 16 is an exemplary graphical user interface rendered by an event prediction server for real-time presentation of sensor data and further for rendering and processing user communications;

FIG. 17 is an exemplary graphical user interface rendered by an event prediction server for real-time presentation of sensor data and further for rendering and processing user profile information;

FIG. 18 is an exemplary graphical user interface rendered by an event prediction server for real-time presentation of sensor data and further for rendering and processing user login information;

FIG. 19 illustrates an exemplary flowchart diagram of method steps of operation of a sensor data ingestion and analysis of data input and further utilizing an artificial intelligence and/or machine learning algorithm;

FIG. 20 illustrates an exemplary flowchart diagram of method steps of utilizing artificial intelligence and training thereof to generate predictive analytics;

FIG. 21 illustrates an exemplary network diagram featuring a computing device connecting to a cloud-hosted platform;

FIG. 22 illustrates an exemplary network diagram featuring multiple computing devices connecting to multiple groups on a cloud-hosted platform;

FIG. 23 illustrates a schematic diagram of exemplary network hardware.

### DETAILED DESCRIPTION

Described herein are systems, methods, and devices for providing a real-time digital engagement experience for users distributed across numerous geographic regions. The systems, methods, and devices described herein may be utilized to enable real-time communal engagement with a live sporting event. Users may view data associated with the live sporting event, view predictions regarding upcoming plays in the live sporting event and submit wagers to engage with the live sporting event. The systems, methods, and devices described herein may be implemented to ensure that all global users synchronously receive data updates in real-time as the live sporting event occurs. The systems, methods, and devices described herein may further be implemented to generate closed groupings of users, and the synchronous data updates for the closed groupings of users may be synchronized with a broadcast time delay associated with a means of viewing the live sporting event, such as broadcast television, streaming, radio, and so forth.

Many sporting leagues utilize sports sensors to enhance performance monitoring and spectator experience. These sports sensors output data that is utilized to track the locations, velocities, movements, and impacts of players and equipment in real-time. By way of example, the National Football League (NFL) in the United States utilizes radio frequency identification (RFID) sensors that are attached to both sides of each players' shoulder pads, and these sensors communicate player movements, speeds, and locations in real-time during games and practices. Further for example, the NFL provides some players with mouth guards that comprise sensors to detect head impacts, and the data output by these sensors may be assessed to track potential injuries and improve player safety. Many sporting leagues and sporting events utilize sensors to obtain real-time information about the game, and the data output by these sensor may be utilized to improve player safety, spectator experience, and coaching decisions.

The data output by sports sensors may be collected by a central data entity and then undergo immediate analysis. The data entity may collect data output by numerous sensors, including sensors attached to or located within equipment such as balls, shoes, helmets, shoulder pads, and so forth. The data entity may collect data output by a variety of sensor types, including, for example, global positioning system (GPS) sensors, RFID sensors, micro-electromechanical systems (MEMS) sensors, thermal sensors, inertial measurement unit (IMU) sensors, biosensors, and so forth. The data is ingested, assessed, and distributed to interested parties in real-time.

In some cases, raw data or pre-processed data is pushed to an event prediction server that utilizes the data to predict upcoming plays that may occur in the live sporting event. The event prediction server may comprise processors for an artificial intelligence and/or machine learning (AI/ML) engine, and the AI/ML engine may be trained to assess player movements, equipment movements, clock time, and other game conditions to predict upcoming plays, formations, and other coaching decisions that a team may make.

The systems, methods, and devices described herein may be implemented to render a graphical user interface (GUI) that displays current field conditions and current game statistics. The GUI may also display any predicted upcoming plays that may occur based on the current game conditions. The GUI may display a real-time animation indicating player location(s), equipment location(s), and other movements as they occur in real-time. Additionally, the GUI may enable users to engage with the game by voting or wagering on predicted upcoming plays that have not yet occurred in the game. Users may further compare their selections with others and compare their selections to the official decisions made by coaches, players, referees, or officials. This provides an extra layer of spectator engagement with the live sporting event.

Further described herein are systems, methods, and devices for providing a predictive sports competition application. An application according to the principles of the present disclosure may feature diverse functionality allowing users to organize, communicate, compete, and place bets on various events such as sporting events. The application may provide users with a point system through which they may bet points on certain decisions made during an event or outcomes of sporting events. The application may provide updates and results in near real time to users and may utilize artificial intelligence to determine a play or other official decision that was called or made, which application users may predict and wage against.

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the methods, systems, and devices herein are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

Reference is made herein to a predictive sports competing application within which a user may observe, track, compete, select, or suggest plays, discuss, bet on, and utilize other functionalities with respect to various sporting events. A user may access an application according to the present disclosure via a computer, mobile device, or other computing device. The computing device may connect via a network to an internet service that can provide real-time information about sporting events to the computing device. The application according to the present disclosure may additionally communicate with other users having their own computing devices within the context of the predictive sports competing application.

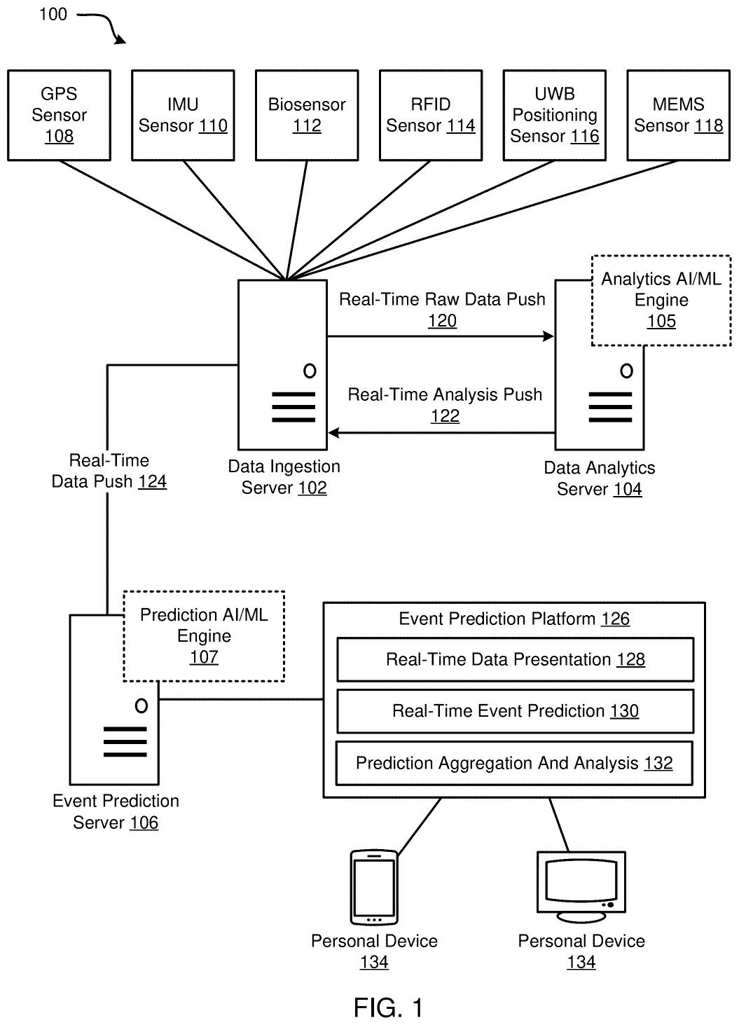

Referring now to the figures, FIG. 1 is a schematic block diagram of a system 100 for data ingestion and analysis. The system 100 may be implemented for pushing real-time sensor data updates to a plurality of user accounts, and further for receiving and analyzing communal predictions provided by the plurality user accounts. The system 100 addresses technical issues pertaining to the real-time ingestion, analysis, and redistribution of sensor data. Additionally, the system 100 addresses technical issues pertaining to the synchronization of user inputs that pertain to real-time current events and are provided and received in an asynchronous manner.

In some cases, it is important to ensure that sensor data is broadly distributed to a plurality of devices in real-time. This may be particularly beneficial if seeking to provide sports-related sensor data to a plurality of devices while a sporting event is ongoing in real-time. The system 100 comprises a data ingestion server 102 that receives sensor data from a plurality of different sensors. The sensors include one or more of a GPS (global positioning system) sensor 108, IMU (inertial measurement unit) sensor 110, biosensor 112, RFID (radio-frequency identification) sensor 114, UWB (ultra-wideband) positioning sensor 116, MEMS (micro-electromechanical systems) sensor 118, and so forth. One or more of the sensors may be utilized in connection with a live sporting event. For example, an RFID sensor 114 may be secured to a uniform of each player within a sporting event, and data from the RFID sensors 114 may be fed to the data ingestion server 102 in real-time. This data may be utilized to determine, for example, the running speed of each player, the position of each player, and so forth.

The system 100 includes a data analytics server 104 in communication with the data ingestion server 102. In some cases, operations performed by the data analysis server 104 are performed locally on the data ingestion server 102, and in other cases (as shown in FIG. 1) data analysis is outsourced from the data ingestion server 102 to the data analytics server 104. The data ingestion server performs real-time raw data pushes 120 to the data analytics server 104. In return, the data analytics server 104 performs real-time data analysis pushes 122 to the data ingestion server 102.

The data analytics server 104 comprises an analytics artificial intelligence and/or machine learning (AI/ML) engine 105. The AI/ML engine 105 of the data analytics server 104 is configured to identify trends and anomalies within the raw sensor data ingested by the data ingestion server 102. The AI/ML engine 105 may comprise a large language model (LLM) configured to generate a textual data output explaining the trends and anomalies identified within the raw sensor data. In some cases, the data ingestion server 102 and/or the data analytics server 104 performs data pre-processing on the sensor data prior to the AI/ML engine 105 analyzing the sensor data. The data pre-processing may include cleaning the sensor data to remove duplicative data entries.

The system 100 includes an event prediction server 106 that receives real-time data pushes 124 from the data ingestion server 102. The event prediction server 106 may receive raw sensor data from the data ingestion server 102 in real-time. The event prediction server 106 may receive pre-processed sensor data from the data ingestion server 102 that has been pre-processed by the data ingestion server 102 and/or the data analytics server 104. The event prediction server 106 comprises a prediction AI/ML engine 107.

The event prediction server 106 executes operations and renders a graphical user interface for an event prediction platform 126. The event prediction platform 126 provides a plurality of functionalities and services to a plurality of user accounts that are signed up with the event prediction platform 126. These functionalities include, for example, real-time data presentation 128, real-time event prediction 130, prediction aggregation and analysis 132, and so forth. The graphical user interface of the event prediction platform 126 is accessible to a plurality of personal devices 134.

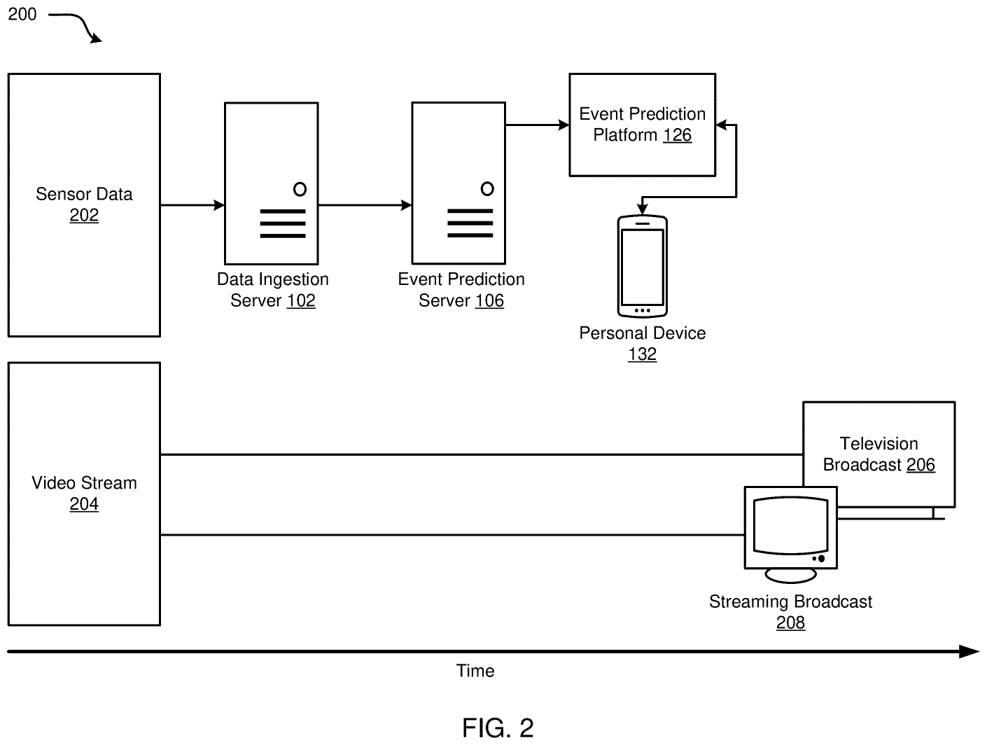

FIG. 2 is a schematic block diagram of a system and process flow 200 for distributing sensor data, video frames, and information through multiple different media channels. The system and process flow 200 may be executed when distributing information pertaining to a real-time event such as a sports event.

The process flow 200 is executed to distribute sensor data 202 and a video stream 204. The sensor data 202 may include sensor data output by one or more of the sensors first illustrated in connection with FIG. 1, including the GPS sensor 108, IMU sensor 110, biosensor 112, RFID sensor 114, UWB positioning sensor 116, and MEMS sensor 118. The video stream 204 may include a recording of the event and may specifically include one or more video streams spliced together that portray various views of a sporting event.

FIG. 2 illustrates the distribution of the sensor data 202 and the video stream 204 over time. The sensor data 202 is virtually instantly provided to the data ingestion server 102 and the event prediction server 106. The event prediction server 106 renders the graphical user interface of the event prediction platform 126 to distribute the sensor data to a plurality of personal devices 132 in near real-time. The video stream 204 is also provided in near real-time, but as shown in FIG. 2, there is a delay in providing a streaming broadcast 208 and/or television broadcast 206 of the video stream 204.

As shown in FIG. 2, a user may experience a time delay in receiving the streaming broadcast 208 and/or the television broadcast 206 when compared with receiving the near real-time sensor data 202 by way of the event prediction platform 126. Because the sensor data 202 is provided in near real-time, a user present at the actual live sporting event will still be able to view sensor data 202 that pertains to the timing of the live event. The user may then make predictions about future events to occur in the live event, and the user may engage in a contest regarding the future events to occur in the live event.

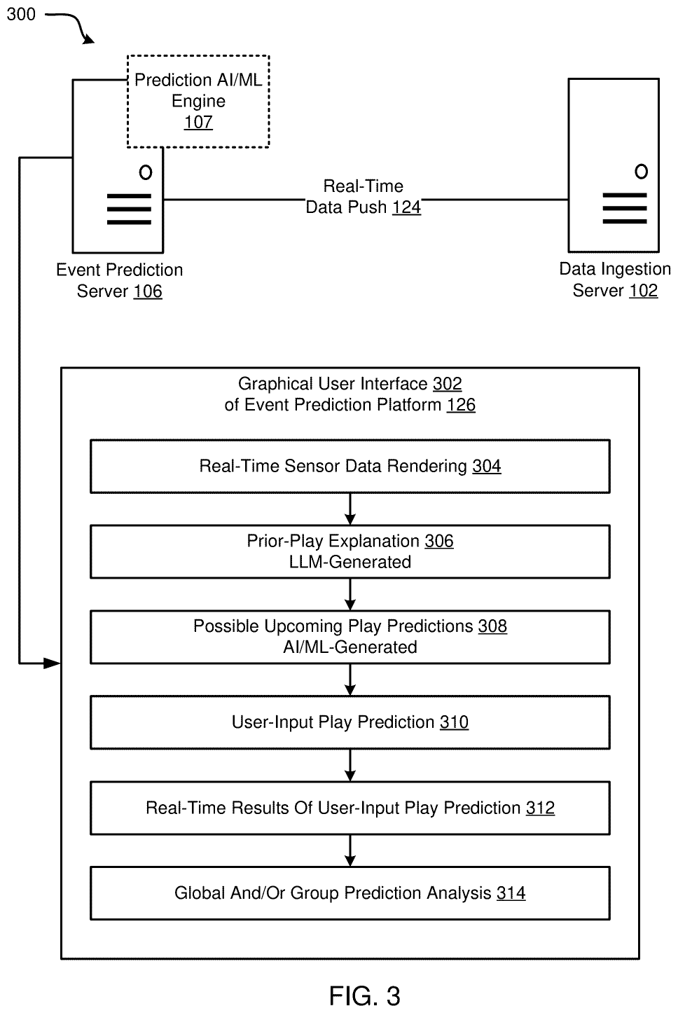

FIG. 3 is a schematic block diagram of a system and process flow 300 for rendering a graphical user interface 302 of the event prediction platform 126. The process flow 300 is executed by the event prediction server 106 and the prediction AI/ML engine 107 in response to receiving real-time or near real-time sensor data pushes from the data ingestion server 102.

The event prediction server 106 renders the graphical user interface 302 to provide a real-time sensor data rendering 304. The real-time sensor data rendering 304 may include, for example, a rendering of the current positions of each player within a sporting event, the current position of a ball or tool within the sporting event, and so forth. The real-time sensor data rendering 304 may additionally include real-time statistics about players, including, for example, the current running speed, the average running speed over the course of the game, and so forth.

The event prediction server 106 renders the graphical user interface 302 to provide a prior-play explanation 306. The prior-play explanation 306 may include a textual explanation that is automatically generated by a large language model (LLM). The AI/ML engine 107 may include an LLM. Additionally, or alternatively, the event prediction server 106 may communicate with an outsources LLM to generate the prior play explanation 306. The prior play explanation 306 is a textual explanation explaining what occurred on a prior play, a prior point, a prior referee call, and so forth.

The event prediction server 106 renders the graphical user interface 302 to provide possible upcoming play predictions 308. The possible upcoming play predictions 308 may be generated by the AI/ML engine 107. The AI/ML engine 107 may be trained on a large dataset comprising numerous plays for a certain sport. The possible upcoming play predictions 308 comprises one or more predictions that may occur in a live sporting event for an upcoming play.

The event prediction server 106 renders the graphical user interface 302 to provide a user-input play prediction 310. The user-input play prediction 310 is a means for a user to provide a play prediction. The user-input play prediction 310 may include a novel play written and generated by the user. The user-input play prediction 310 may include a selection of one of the one or more possible upcoming play predictions 308 that were suggested by the event prediction platform 126.

The event prediction server 106 renders the graphical user interface 302 to provide real-time results of the user-input play prediction 312. These real-time results are provided after the user-input play prediction 310 is submitted, and further after the next play has actually occurred in the live sporting event. The real-time results of user-input play prediction 312 may indicate whether a user was correct in predicting what the next play would be.

The event prediction server 106 renders the graphical user interface 302 to include global and/or group prediction analysis 314. The global and/or group prediction analysis 314 includes an analysis of how other users communicating with the event prediction platform 126 predicted a certain play would go. Additionally, the global and/or group prediction analysis 314 may include an indication of how many users and/or what ratio of users correctly predicted a certain play.

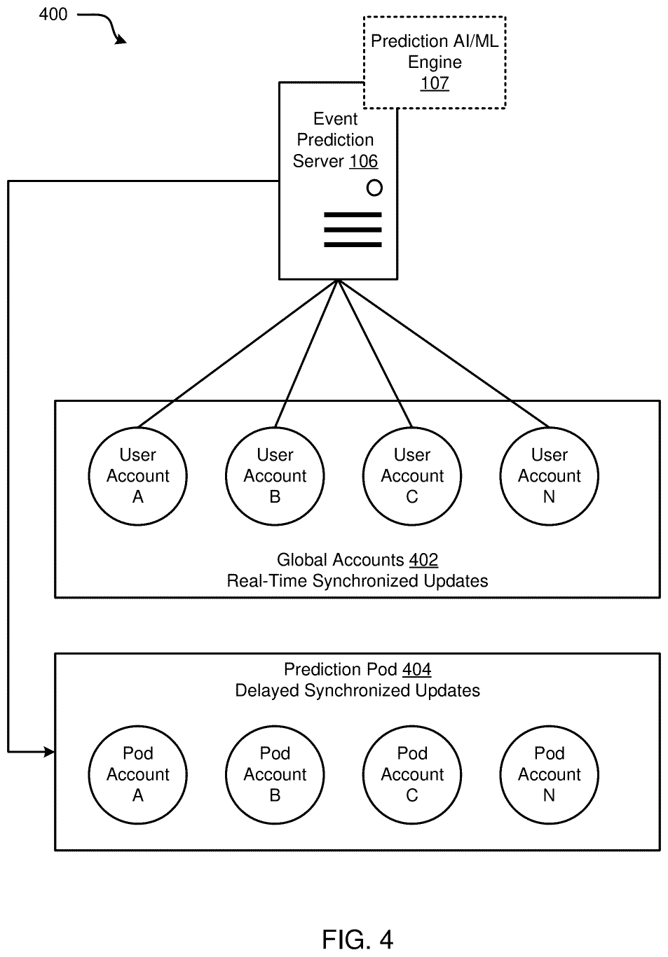

FIG. 4 is a schematic block diagram of a system and process flow 400 for asynchronous data distribution. The process flow 400 is executed to asynchronously push data to different user accounts depending on whether those user accounts are within a “prediction pod” 404.

The event prediction server 106 may automatically push real-time sensor data updates to global accounts 402, which includes a plurality of user accounts distributed across the globe. The global accounts 402 are solo accounts that are not currently associated with a prediction pod 404.

The event prediction server 106 may throttle the pushing of sensor data updates to user accounts within a prediction pod 404. The prediction pod 404 comprises two or more user accounts that are currently associated with one another. The two or more user accounts may be associated with personal devices that are currently located at the same geographical location. This may indicate, for example, that the individuals associated with the user accounts within the prediction pod 404 are currently attending a live sporting game in-person, are currently attending a sporting event watching party at one location, are currently communicating with one another while watching a live sporting event, and so forth. The event prediction server 106 ensures that sensor data updates to all user accounts within the prediction pod 404 are provided simultaneously. This ensures that no user account within the prediction pod 404 receives an advantage by receiving sensor data prior to other user accounts within the prediction pod 404.

The event prediction server 106 automatically provides sensor data updates global accounts 402, but in some cases, these sensor data updates are provided asynchronously. This may occur if certain user accounts are communicating with a server that is located in a different geographical location.

The event prediction server 106 push sensor data updates to a global account 402 to ensure the sensor data update is synchronized with a certain broadcast of a live sporting event. A global user account may indicate that the user is viewing the live sporting event through a certain television broadcast or streaming service. The event prediction server 106 may then synchronize the sensor data updates with the identified television broadcast or streaming service. This ensures the user receives the sensor data updates and the video stream at the same time.

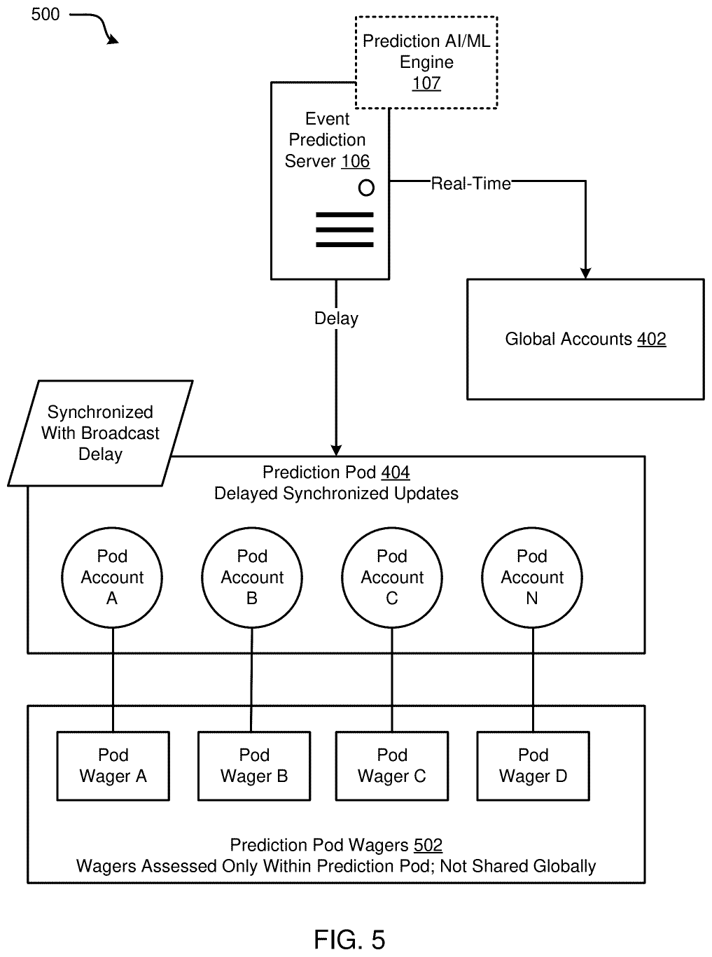

FIG. 5 is a schematic block diagram of a system and process flow 500 for data distribution and ingestion of user inputs. The system includes the event prediction server 106 and the prediction AI/ML engine 107. The event prediction server 106 is in communication with global accounts 402 and is additionally in communication with a plurality of accounts within a prediction pod 404.

The event prediction server 106 pushes real-time data updates to the global accounts 402 such that the global accounts 402 receive updates nearly instantaneously. This ensures there is no unfair advantage between global accounts 402 if some users are present at the live game while other users are viewing the game via broadcast television, streaming, radio, or some other means.

In some cases, a plurality of users may elect to form a prediction pod 404 for a game. The users within the prediction pod 404 may indicate that data updates should be synchronized with a delayed distribution, such as broadcast television, streaming, radio, or another means for viewing or listening to the live sporting event. The users within the prediction pod 404 agree that all data distributions will be delayed relative to global accounts 402. In this case, wagers input by members of the prediction pod 404 (see prediction pod wagers 502) will remain within the prediction pod 404 and will not be distributed to other global accounts 402.

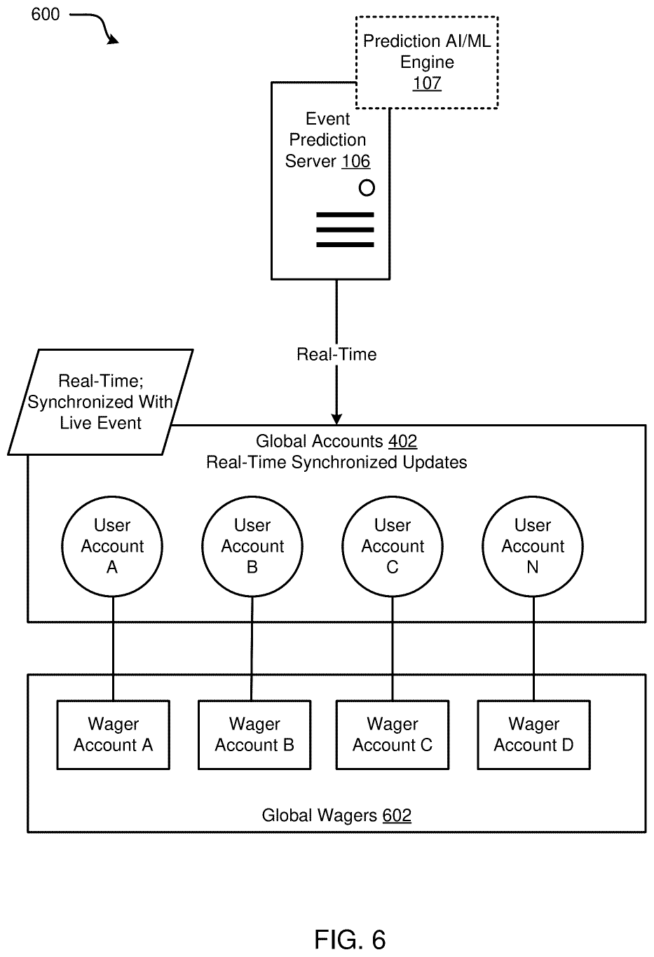

FIG. 6 is a schematic block diagram of a system and process flow 600 for data distribution and ingestion of user inputs. The system includes the event prediction server 106 and the prediction AI/ML engine 107. The event prediction server 106 is in communication with global accounts 402 that receive real-time synchronized data updates that are virtually instantaneous relative to the live sporting event.

Each of the global accounts 402 is synchronized such that all accounts receive data updates at the same time. The global accounts may each input a global wager 602 that is wagered with all other global accounts 402. The global wagers 602 are not intermingled with the prediction pod wagers 502 discussed in connection with FIG. 5.

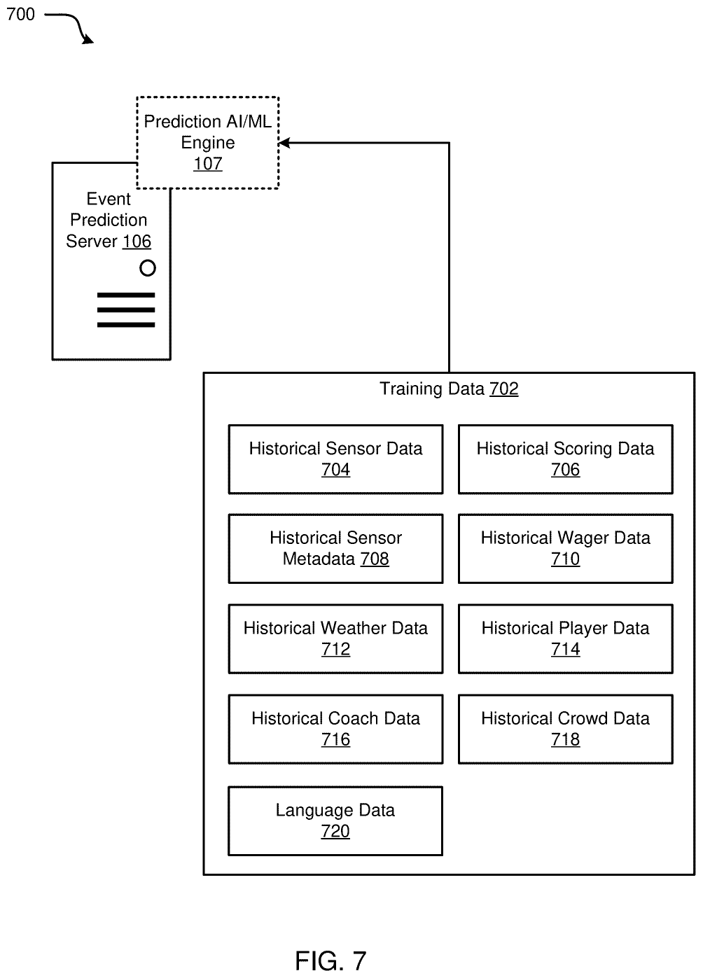

FIG. 7 is a schematic block diagram of a system 700 for training the prediction AI/ML engine 107. The prediction AI/ML engine 107 is trained with a large quantity of training data 702. The training data 702 may include one or more of historical sensor data 704, historical scoring data 706, historical sensor metadata 708, historical wager data 710, historical weather data 712, historical player data 714, historical coach data 716, historical crowd data 718, or language data 720.

The historical sensor data 704 comprises prior sensor data outputs from sports sensors, such as the sensors 108-118 discussed in connection with FIG. 1. The historical sensor data 704 may be assessed in conjunction with historical sensor metadata 708, which may include additional information about the sensor data outputs such as timestamps, player identity, equipment identity, and so forth. The sensor data timestamps may be compared against historical scoring data 706 to identify what plays were performed when a team had a certain score or when the difference between scores was within a certain threshold. The sensor data timestamps may further be compared against the game sequence to determine when a certain play was performed over the duration of the game.

The historical wager data 710 comprises prior wagers that have been submitted for various types of predicted upcoming plays. The historical wager data 710 further comprises information on which wager positions were successful, what payouts were made for various wagers, and what fees were collected for wagers. The prediction AI/ML engine 107 is trained on the historical wager data 710 in view of the historical sensor data 704 to determine a minimum wager buy-in for various predicted upcoming plays.

The historical weather data 712 comprises information regarding the current weather conditions when historical sensor data 704 and historical scoring data 706 was captured. The prediction AI/ML engine 107 is trained on the historical weather data 712 in view of other training data 702 such that the AI/ML engine 107 may factor in current weather conditions when predicting potential upcoming plays and further when assigning minimum wager buy-ins for selecting any of the potential upcoming plays.

The historical player data 714 comprises information regarding the identity and statistics of players within a sporting event. The AI/ML engine 107 is trained on the historical player data 714 to aid in predicting an upcoming play by the player, and further to aid in predicting whether the upcoming play is likely to be successful.

The historical coach data 716 comprises information regarding the identity and statistics of coaches associated with a sporting event. The AI/ML engine 107 is trained on the historical coach data 716 to aid in predicting an upcoming play by a team, and further to aid in predicting whether the upcoming play is likely to be successful.

The historical crowd data 718 comprises information regarding “home court advantage” that may be associated with a sporting event being played at a certain location. The historical crowd data 718 may further comprise information regarding prior crowd engagement, and whether spectators are likely to engage in wagering on a particular game or play.

The language data 720 comprises large sums of text and may specifically include text pertaining to sports plays and outcomes. The prediction AI/ML engine 107 may comprise a large language model (LLM) trained to generate plaintext explanations of actions that have occurred or are likely to occur in a live sporting event.

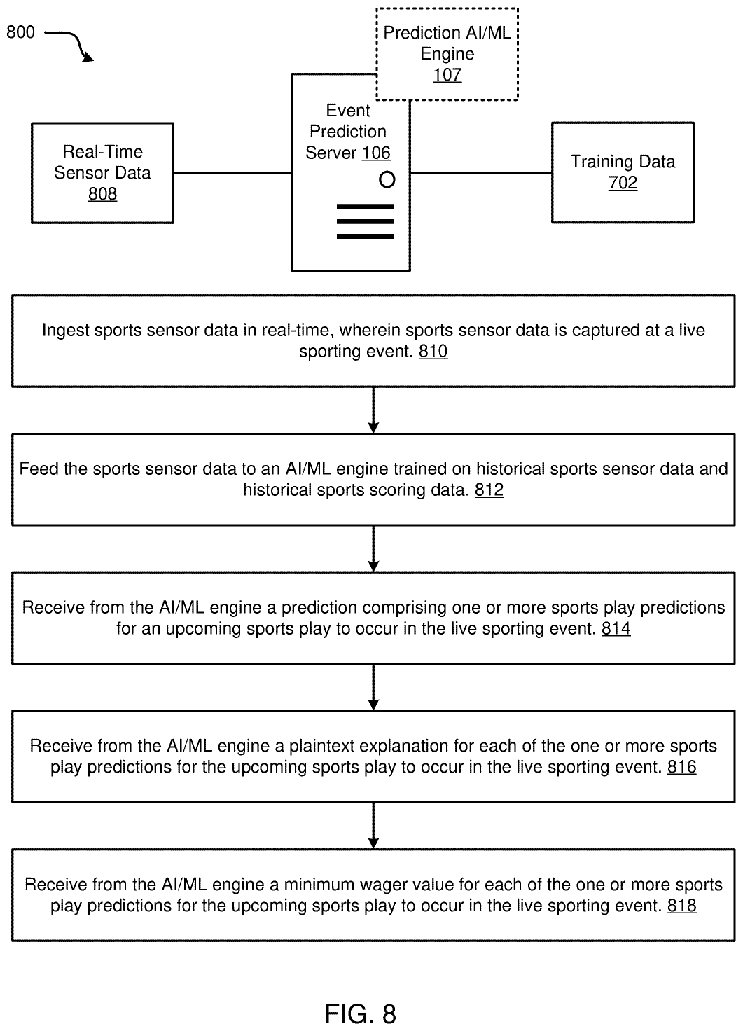

FIG. 8 is a schematic flow chart diagram of a method 800 for predicting upcoming sports plays and assigning minimum wager values to the potential upcoming sports plays. The method 800 may be performed by the event prediction server 106 and/or the AI/ML engine 107. The event prediction server 106 may retrieve real-time sensor data 808 and training data 702.

The method 800 includes ingesting at 810 sports sensor data in real-time, wherein the sports sensor data is captured at a live sporting event. The sports sensor data may comprise data output by any of the sensors described herein and may specifically include data output by any of the sensors 108-118 described in connection with FIG. 1. The method 800 includes feeding at 812 the sports sensor data to an AI/ML engine (see, e.g., prediction AI/ML engine 107) trained on historical sports sensor data and historical sports scoring data. The method 800 include receiving at 814 from the AI/ML engine a prediction comprising one or more sports play predictions for an upcoming sports play to occur in the live sporting event. The method 800 includes receiving at 816 from the AI/ML engine a plaintext explanation for each of the one or more sports play predictions for the upcoming sports play to occur in the live sporting event. The method 800 includes receiving at 818 from the AI/ML engine a minimum wager value for each of the one or more sports play predictions for the upcoming sports play to occur in the live sporting event.

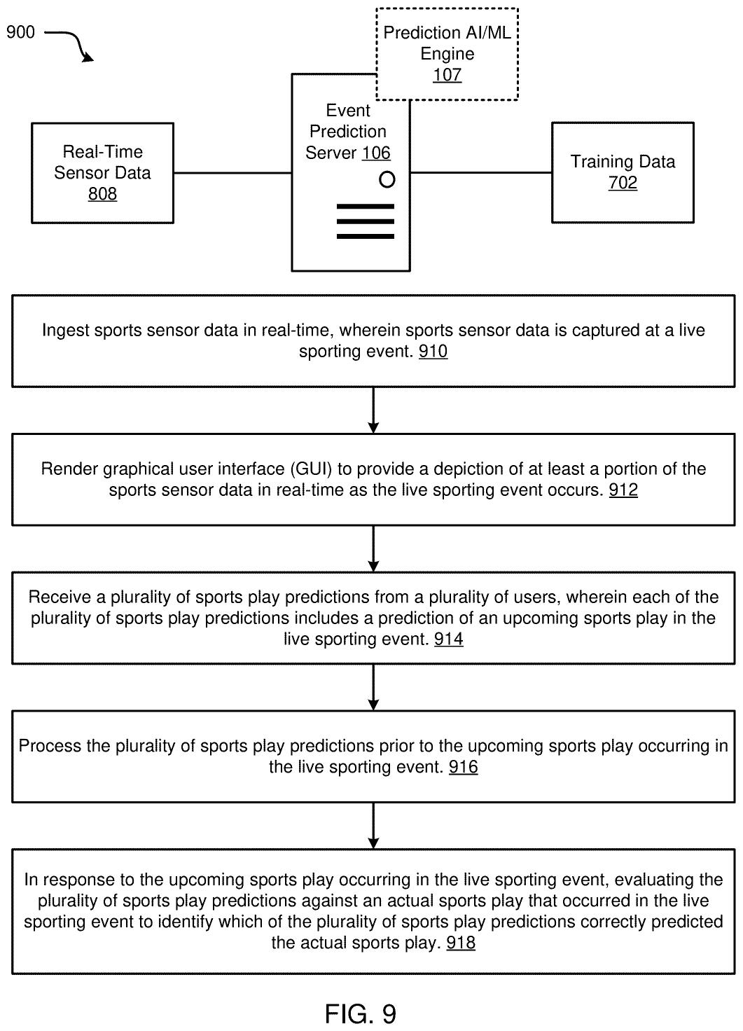

FIG. 9 is a schematic flow chart diagram of a method 900 for ingesting and processing user engagement with a live sporting event. The method 900 may be performed by the event prediction server 106 and/or the AI/ML engine 107. The event prediction server 106 may retrieve real-time sensor data 808 and training data 702.

The method 900 includes ingesting at 910 sports sensor data in real-time, wherein the sports sensor data is captured at a live sporting event. The method 900 includes rendering at 912 a graphical user interface (GUI) to provide a depiction of at least a portion of the sports sensor data in real-time as the live sporting event occurs. The method 900 includes receiving at 914 a plurality of sports play predictions from a plurality of users, wherein each of the plurality of sports play predictions includes a prediction of an upcoming sports play in the live sporting event. The method 900 includes processing at 916 the plurality of sports play predictions prior to the upcoming sports play occurring in the live sporting event. The method 900 includes, in response to the upcoming sports play occurring the live sporting event, evaluating at 918 the plurality of sports play predictions against an actual sports play that occurred in the live sporting event to identify which of the plurality of sports play predictions correctly predicted the actual sports play.

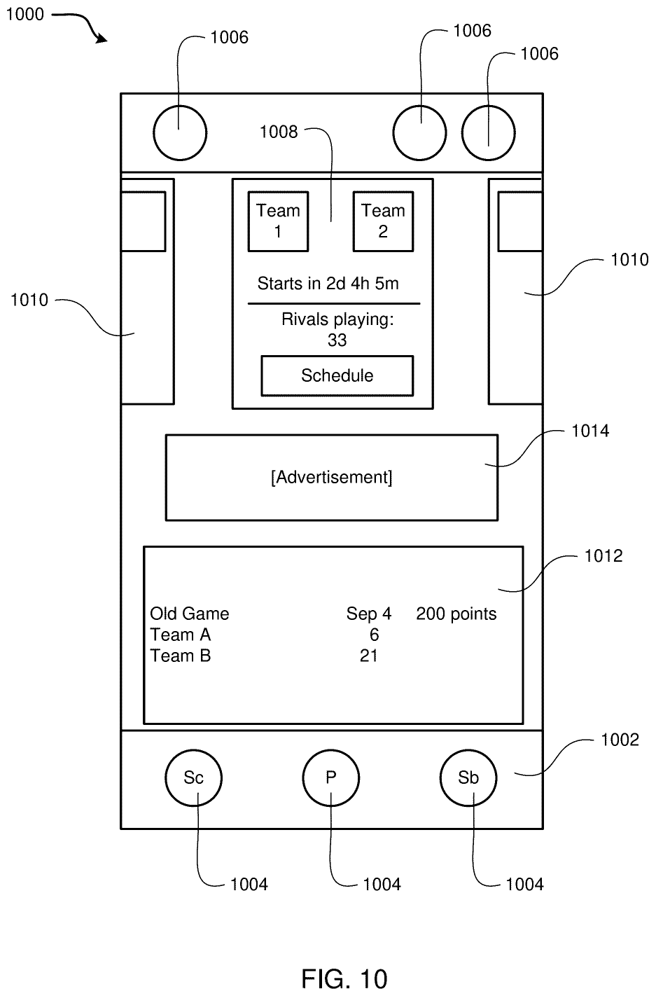

FIG. 10 shows exemplary graphical user interface rendered by an event prediction server for real-time presentation of sensor data and further for rendering future events. It should be appreciated that the user interface elements and arrangement thereof shown throughout the figures are exemplary, and those skilled in the art will appreciate the sizing, arrangement, and other design considerations may be altered without departing from the scope of the disclosure. A scheduling screen 1000 may serve as a landing screen following a login whereby a user may view upcoming sporting events, view previous sporting events, or both, depending on the implementation. The schedule screen may feature a navigation window 1002 having navigation buttons 1004 to navigate between various screens of the application. In some implementations the window 1002 may be shown in a bottom portion of the screen 1000, while in other implementations the window 1002 may be located in other positions on the screen 1000. The window 1002 may additionally be “persistent” such that it displays on any screen visited on the application. The navigation buttons 1004 may allow a user to quickly navigate between various screens of the application, and in some implementations a user may customize which screen a button 1004 “jumps” to. The application may feature additional navigation buttons 106 that allow quick access to other screens, such as a profile screen, settings screen, or others (discussed in later figures). The additional navigation buttons 106 may or may not also be persistent and may optionally display on some screens and not display on others.

The scheduling screen 1000 may feature in a central position of the screen a primary upcoming event window 1008 featuring details of an upcoming sporting event. The window 1008 may provide information about teams or players involved in the event, time until start, how many other users are following the event, and more. The information about players, time, other users, and other information may be obtained from a database and updated on a user's screen in real-time. The window 1008 may additionally feature a type of confirm button, labeled as “schedule” in the example, which may allow a user to log a particular sporting event. By logging an event, a player may be notified to keep track of details about the event and participate in competing in the event. The scheduling screen 1000 may additionally display other upcoming events in secondary event windows 1010. In FIG. 10, an exemplary configuration is shown whereby the primary upcoming event window 1008 and secondary upcoming event windows 1010 are displayed horizontally and a user may “swipe” their screen to cycle a secondary upcoming event window 1010 into a central position, thus setting that window as the primary upcoming event window 1008. Those skilled in the art will appreciate that the windows 1008 and 1010 may be reconfigured to display vertically, in a queue, in a dropdown box, or in other configurations that would allow a user to browse various upcoming games, depending on the implementation.

The scheduling screen 1000 may additionally feature a previous event window 1012. Previous events a user has participated in or logged may be displayed in the window 1012 along with information about that game, such as which teams or athletes participated, final scores, the number of points gained or lost by the user (discussed in other figures), and more. In FIG. 10 the previous event window 1012 is shown fully within the boundaries of the screen. In some implementations, the window 1012 may be partially transparent, or partially hidden offscreen, and a user interacting with the window 1012, for example, by tapping, may cause the window 1012 to become fully opaque or otherwise fully appear on screen in order for a user to observe and interact with the window 1012, depending on the implementation. A scheduling screen 1000 may additionally feature an advertisement window 1014. In the window 1014, various advertisements may appear to inform users of a variety of products, services, or other information. While shown in a central position of the screen in FIG. 10, an advertisement window 1014 may alternately appear anywhere within the screen 1000, and the window itself may be differently sized or of varying opacity depending on the implementation. An advertisement displayed in an advertisement window 1014 may be static and change upon switching to a different screen in the application. In other implementations an advertisement window may refresh periodically over a time to display new advertisements. While shown in FIG. 10 in the figures, the advertisement window 1014 may appear in any position in any screen discussed in this disclosure.

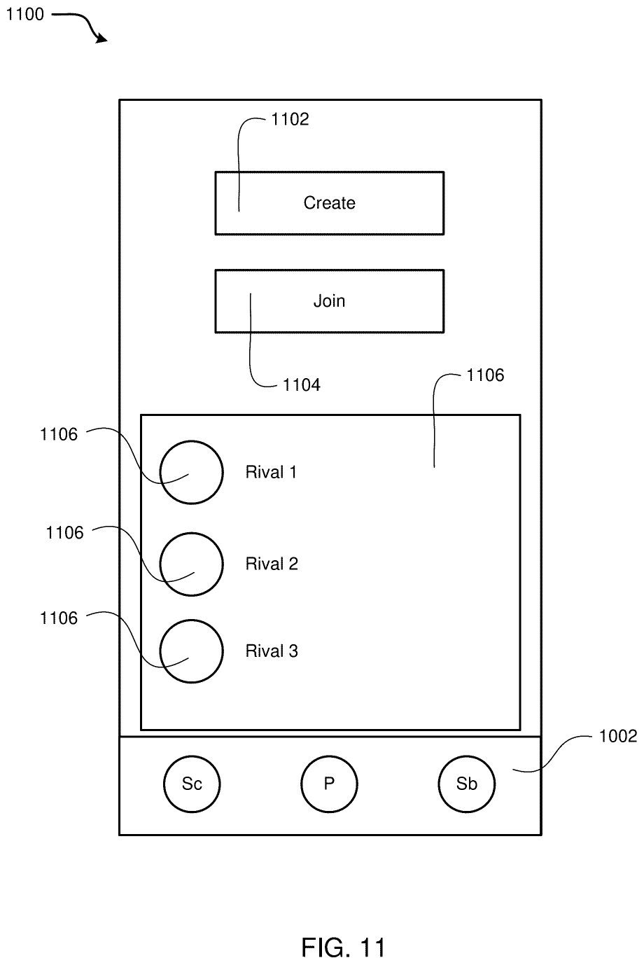

FIG. 11 shows exemplary graphical user interface rendered by an event prediction server for real-time presentation of sensor data. A group screen 1100 may display various information about groups or other users a user is involved with or may interact with. A user may interact with other groups or users via user interface elements, such as create 1102 or join 1104 buttons. A user may create or join a “group” which groups various users into one category whereby all grouped users may interact with one another. In other contexts, the create 1102 and join 1104 buttons may refer to creating or joining a particular event with other users. While FIG. 11 shows the create 1102 and join 1104 buttons with particular labels, it should be understood that these labels are exemplary and may feature alternate labels or different arrangements of user interface elements depending on the implementation.

A group screen 1100 may additionally feature a user list 1106 showing other users on the application. Other users may be displayed according to various filters, such as users within the same group, similar geographic area, joined to the same event, and others. The list 1106 may show various information about the users displayed, like name, point, score, number of wins, and other information.

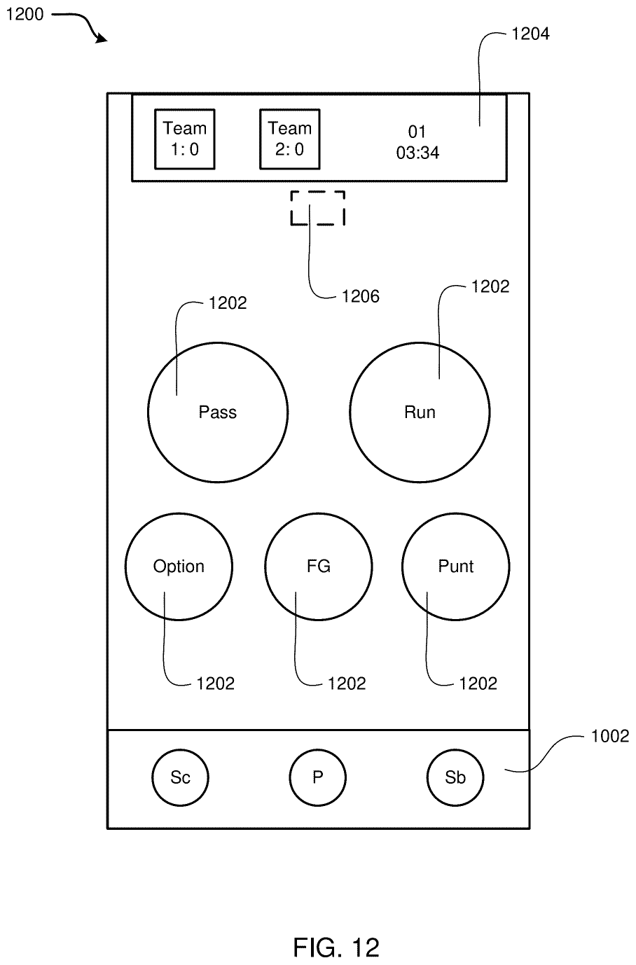

FIG. 12 shows an exemplary graphical user interface rendered by an event prediction server for real-time presentation of sensor data. Once a user joins an event and an event begins, a user may be able to select from a list of plays, formations, or other decisions an athlete or team may make in a particular sporting event. The predictive sports competing application may connect to a server and database owned by a sporting institution or similar entity over a network. With this connection, the application may be able to receive real-time updates as a sporting event takes place. The application may receive information such as player formations, play clock timers, referee decisions on penalties or goals, or other similar information in real-time.

FIG. 12 shows an exemplary football context whereby numerous option buttons 1202 are displayed. These buttons 1202 represent different plays a football team may utilize, such as “pass,” “run,” or others. In other contexts, such as soccer, option buttons 1202 may alternatively display possible formations, players who could be subbed in or out, or other decisions a team may make. Those skilled in the art will appreciate what other strategies or decisions a team or athlete may need to make depending on the sporting context, and how the option buttons 1202 may be configured to accommodate those decisions. It should also be noted that the labeling and arrangement of buttons 1202 are exemplary and may be resized or repositioned according to the implementation.

The action screen 1200 may additionally feature a status window 1204. The status window 1204 may display various information to serve as a quick reference on the status of a sporting event. In the exemplary implementation shown, the status window 1204 displays information of the current score between two teams, and information showing a down and a play clock for a football context. This information may be received over a network connection with a sporting institution such that the information is obtained and updated in real time. In other implementations, the team information may instead be score between two individual athletes and the clock may show quarters or halves and time remaining in those quarters or halves, depending on the implementation.

An action screen 1200 may additionally feature a notification icon 1206. The notification icon may represent a colored light or other symbol that may change visually to represent how much time a user has to select from the option buttons 1202. The icon 1206 may blink, pulse, change color, or perform some other visual indication, and may blink or pulse faster, or change color to a darker or lighter color to demonstrate when a user is running out of time to select. While shown in an upper portion of the screen 1200, it should be appreciated that all user interface elements shown may be resized or repositioned elsewhere on the screen.

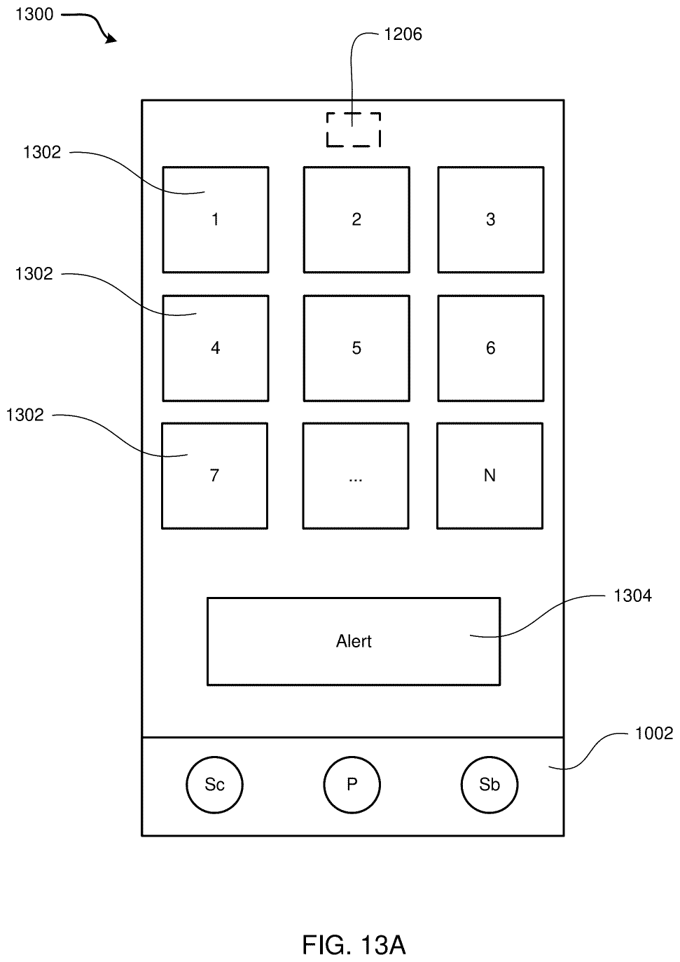

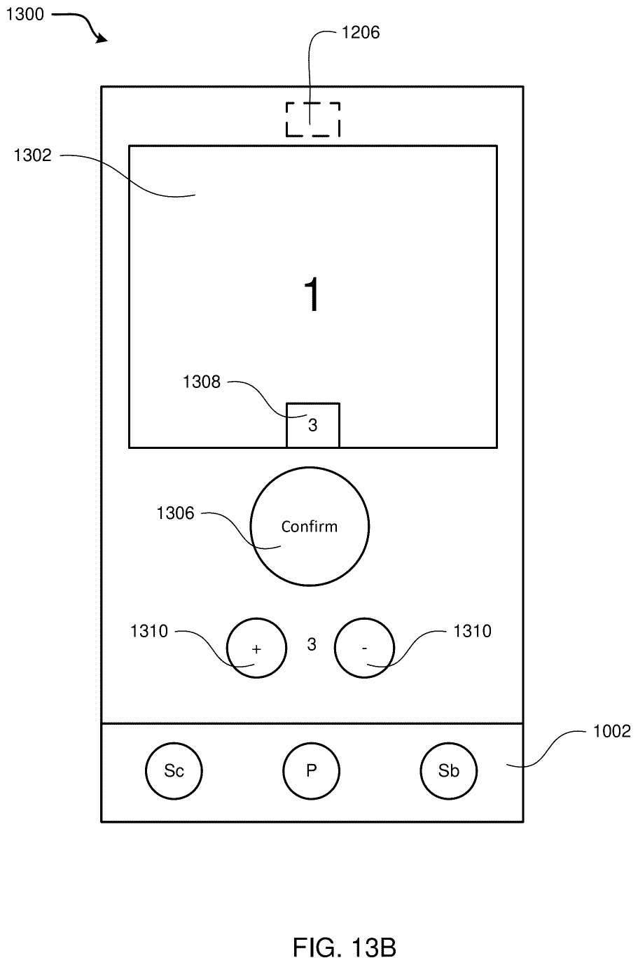

After selecting an option from among the option buttons 1202 in FIG. 12, on a sub-screen 1300 a user may select from a plurality of action buttons 1302 representing subcategories of the option selected, as seen in FIG. 13A. The action buttons 1302 in FIG. 13A are labeled 1-N, and the labeling may vary according to the context. For example, in a football context, the action buttons may represent play diagrams a team may call. In other contexts, like soccer or basketball the action buttons may represent player formations. In contexts like bowling, action buttons 1302 may display possible arrangements of remaining pins. Those skilled in the art will appreciate that various sporting contexts are contemplated and how they might be implemented within the scope of the disclosure. What options are presented to users may update and change in real-time as an event progresses. For example, a user may one moment be presented options to bet on a formation in a soccer game. If the ball goes out of bounds, the user may instead be presented options to bet on which team will receive the free throw and which player will perform the throw. Once the user selects, the user will receive feedback on whether their choice was correct or not in real-time as the events unfold at the event.

The action buttons 1302 may additionally display a number indicating a point value, discussed further in FIG. 13B. The point value of each of action buttons 1302 may vary depending on the event, game, team, or other factors. For example, the point value of a particular play in a football context may vary according to the risk relative to a particular down, how often a team utilizes that play, or other factors. An artificial intelligence system may utilize a live telemetry data determining the call that was executed by a coach, quarterback, team, or another to vary the point value of a play or decision according to the play that was executed, how often a team utilizes that play, how often the play is successful, how many other users bet on the play, or many other factors. The point value may be varied on a play-by-play basis, game-by-game basis, or other time suitable to the needs of the situation. The number of action buttons 1302 may vary, and the sizing and positioning of the user interface elements representing the actions may vary according to the implementation.

Additionally, action buttons may feature animations. The predictive sports competing application may connect to a real-time stream of information over a network provided by a sporting institution. Access to this information allows the predictive sports competing application to update live and in real time with information like player formations, play clocks, and other information. When a user goes to select an action button 1302, the button may be animated to display how a particular choice may play out. For example, in a football context the action button may show a play chart animated to show how different players will move. In a soccer context, the action buttons may feature team formations during general play or may show animated sprites of players that may be chose to perform a freekick.

While action buttons 1302 are specifically discussed here as being animated, it will be appreciated that any and all icons, buttons, and other components of the predictive sports competing application may be animated either featuring simple animations or more complex animations animated according to real-time information obtained from a sporting institution about the sporting event.

While selecting, the action selection sub-screen 1300 may additionally display an alert window 1304. The window 1304 may be persistently displayed, pop-up, slide onto the screen, or appear in diverse ways to display information that may be pertinent to the user. For example, the alert window may display time remaining to select, when a user joins or leaves a group or event, or other information. The action selection sub-screen 1300 may additionally feature the notification icon discussed in FIG. 12.

Turning to FIG. 13B, once selected, a specific action button 1302 may expand to occupy a larger portion of the sub-screen 400 and increase visibility for a user. A sub-screen 1300 may additionally display confirmation buttons 1306 and point (or betting) buttons 1310. The confirmation button 1306 may be used to confirm the action 1302 selected by the user. Depending on the implementation, selecting the confirm button 1306 may “lock-in” the user's choice, committing the user to that selection. In other implementations a user may be allowed to freely cycle between the screens of FIGS. 13A and 13B to change their choice so long as time or another factor permits. The point buttons 1310 may be used to increase or decrease a number of points a user may apply or bet on a play before confirming the selection. Depending on the implementation, each selectable action 1302 may have an associated point value 1308. The point value may display on the sub-screen 1300 of FIG. 13A, 13B, or both. This value may serve as the default amount a user may bet on the action. The user may use the betting buttons 1310 to increase or decrease an amount of points the user wishes to bet on the action. In some implementations a user may not be able to select an action 1302 if they do not have enough points to meet the associated point value 1308. In other implementations, a user may be permitted to bet more points than they have and potentially enter a deficit. In yet other implementations, a user may be allowed to freely select an action 1302 without needing to bet any number of points in an implementation where users simply compete in a game without betting any points.

Each user may have a point value associated with it. Some number of points may be added to a user's account upon account creation, when a new season of a particular sport starts, or at other similar times. In some implementations a user may obtain more points through successful predictions or bets during games. A user may additionally earn points through winning games or earning various rewards (discussed in later figures). In some implementations the application may feature a microtransaction system in which a user may enter bank account or debit/credit card information to purchase more points. In yet other implementations users may be able to send some of their own points to another user.

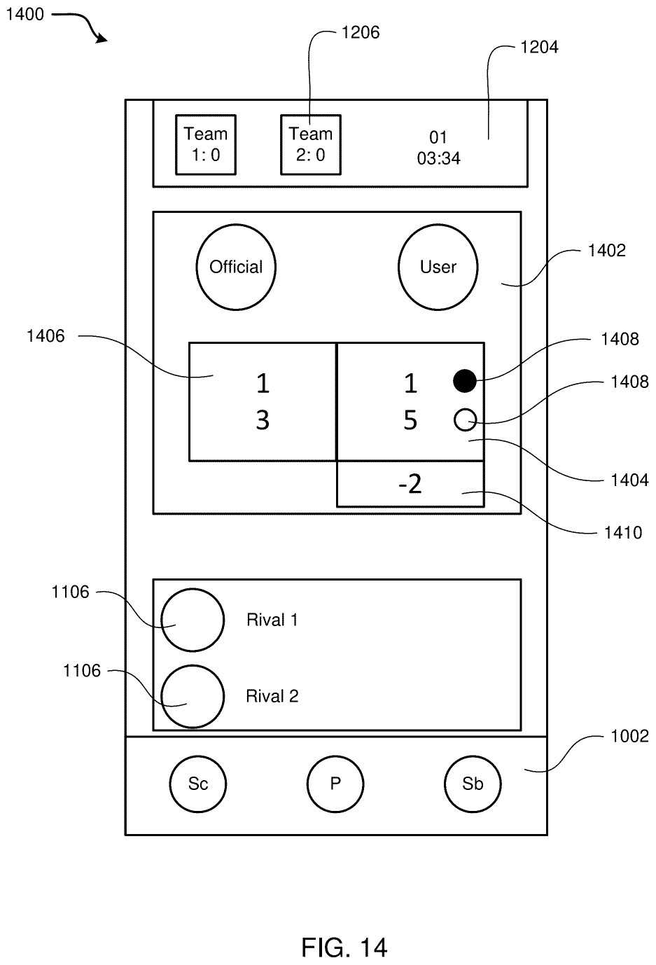

Once a user has chosen and confirmed an action as described in FIGS. 13A-13B, a user may be directed to exemplary results screen 1400 shown in FIG. 14. The results screen 1400 may show a user list and status window 1204 discussed in FIGS. 11 and 12 respectively, as well as a results window 1402. Results window 1402 may show the results of the action selected in FIGS. 13A-13B compared to an official decision in a real sporting event. In results sub windows, displayed here as user sub window 1404 and official sub window 1406, information may be displayed showing a user selection on one side in user sub window 1404 and an official call or decision in official sub window 1406.

A results indicator 1408 may display to serve as a visual indicator of whether the user correctly anticipated the official decision. As shown in the implementation of the exemplary figure, the user first chose option 1, which was also the official decision, causing the user to gain points according to however many were applied or bet. On a subsequent decision, the user chose option 5, whereas the official decision was option 3, causing the user to lose points. Points sub window 1408 may show a total of points gained or loss across a subdivision of time and may display after all decisions within a subdivision of time or may function as a running score that updates in real time as more decisions are bet on. When a user has selected in advance of an official decision being announced, the official sub window 1404 may display a message such as “pending” to indicate that an official decision has not yet been made or the application is awaiting that information. Additionally, as other users in user list 1106 make decisions, the user list 1106 may update to show options selected by those other users, as well as points gained or lost as such decisions are made. These updates may happen in real-time or after a certain subdivision of time elapses.

In some implementations, an artificial intelligence (AI) system may be employed. The AI/ML engine 105 may receive and consider the telemetry data of the players and ball on the field after a user selection is made and before or after an official decision is received. The player may gain or lose points depending on the AI's decision and how the AI's decision compares to the official decision received. The AI/ML engine 105 may be trained on play movements made from previous sporting events in similar circumstances and may additionally be trained on selections made by users in previous events having similar circumstances. Depending on previous plays, decisions made by coaches, and even calls made by officials and selections made by users, the AI/ML engine 105 may be able to correctly determine the call that was made by a coach, quarterback or other team captain, or other players or staff, resulting in the play that just occurred.

To assist the AI, in sporting events, physical hardware such as RFID chips or software calculations or solutions may be used to track locations of players, balls, or other relevant actors on a field, pitch, a. This information may be calculated live during a sporting event or may be generated after the fact through footage and data of previously recorded events. Training models may be fed information about positioning of actors, balls, and outcomes to aid the AI/ML engine 105 in learning different field formations, plays, and other situations that lead to certain decisions being made or determining decisions that were made. A human may review the information fed to the AI/ML engine 105 and review the decisions made by the AI/ML engine 105 and correct any errors if necessary.

In some implementations, the application may receive official decision information through a human attending the sporting event in person or watching the event on a television or online. In other implementations, the application may have access through a sporting event API whereby the application and AI/ML engine 105 can receive telemetry data and/or decision information from sporting coaches and officials in real time.

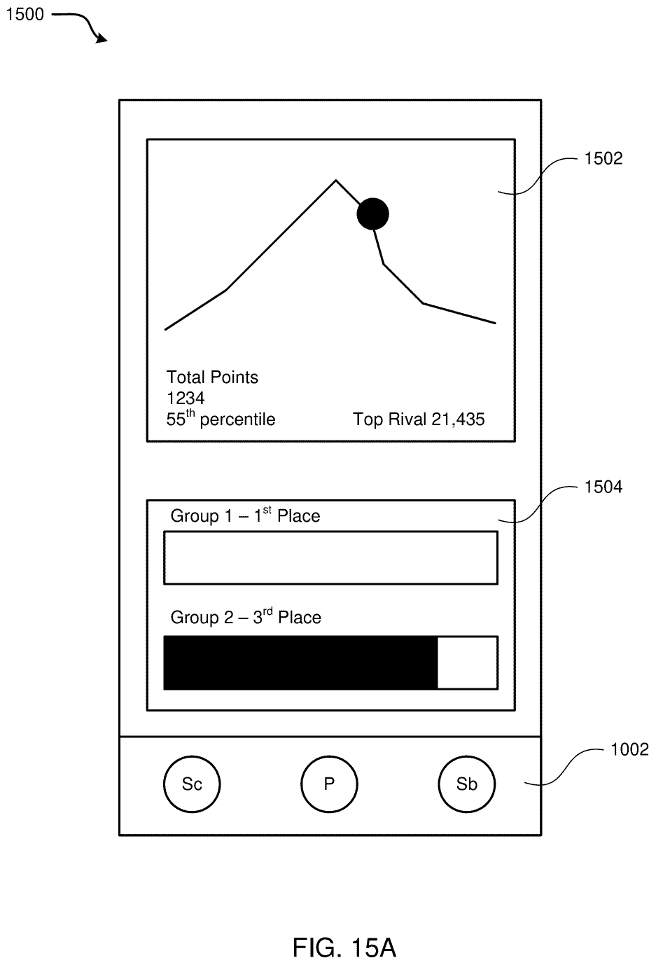

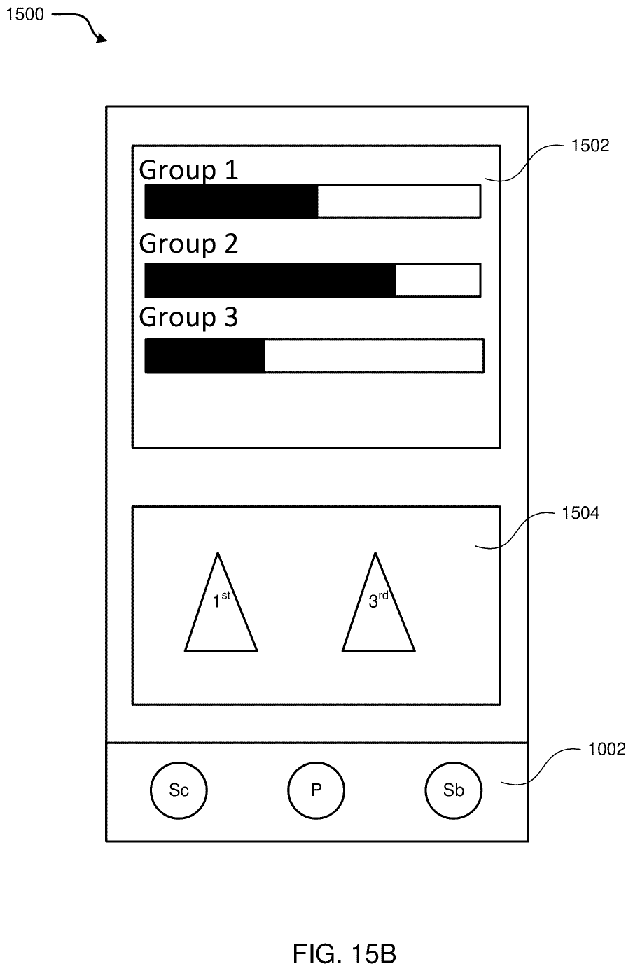

In the exemplary implementation shown in FIG. 15A, a score screen 1500 may display a point chart 1502 and a ranking chart 1504. The point chart 1502 may display information textually, visually, both, or otherwise indicating to a user how many points they have, how their point total ranks them compared to other users, a closest other user according to the number of points the other user has, and other information. The point chart 1502, as with other graphics and information in the application, may be animated in some way to enhance visualization of the information Exemplary point chart 1502 shows that a user has 1234 points and ranks in the 55^{th} percentile. This percentile may indicate a percentile within a particular group, league, overall, on the application, or some other subdivision. Ranking chart 1504 may display, textually, visually, both, or otherwise, information indicating how a user ranks compared to other users, other groups, other leagues, or other subdivisions of users. In exemplary ranking chart 1504, two groups are shown, Group 1 and Group 2. The chart indicates that the user, based on their point total, currently ranks first in Group 1 but third place in Group 2. As a user gains or loses points during an event, the user's rankings may update in real time in some implementations. In other implementations the rankings may only update after an event has ended.

The score sub screen 1500 shown in FIG. 15B may feature additional windows showing rankings of groups a user is in compared to other groups in group ranking window 1506 and awards such as trophies in award window 1508. Group ranking window 1506 may display information, textually, visually, both, or otherwise indicating how one or more groups a user participates in compares to other groups. These rankings may be decided by total points of a group with respect to a particular event, a league, overall, on the application, or other contexts. Award window 1508 may display icons representing achievements awarded to a user. If a user wins the most points in a particular event or league, a user may get a “first place trophy” represented by an icon in award window 1508. Other awards may exist and be awarded, such as awards for certain consecutive number of days logged in, number of correct predictions, number of plays participated in, number of games lost, or other events logged by the application. The information described above including ranking information, score information, league data, and more may be updated in real-time as the user utilizes the application.

A user may be incentivized to create a league or join an existing league structure. Leagues may be directed to particular events or sporting events, but may also be celebrity leagues, player leagues, team leagues, or fan leagues. Users may be able to earn points by participating in leagues even without active participation in a particular event based on the performance of other users in the league.

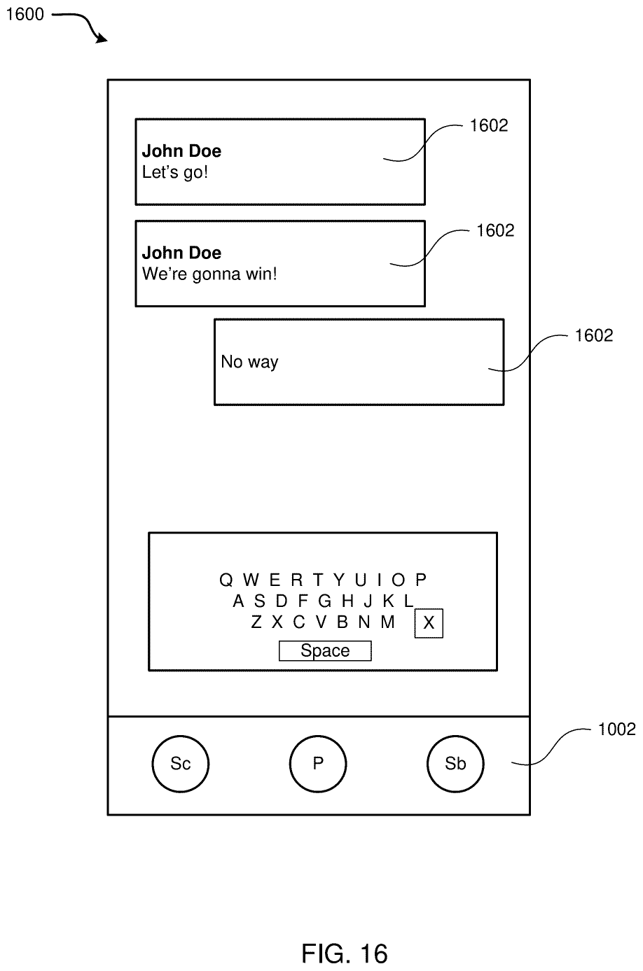

The application may feature a screen 1600 facilitating communication between one or more users as seen in FIG. 16. Users may communicate directly with one another or among multiple users within a group, league, or other grouping of users. When communicating, messages 1602 may be displayed chronologically and may contain, beyond the contents of the message, metadata indicating a time the message was sent, an indication of whether the message was read, whether the users belong to the same group, or other information. In another implementation, a communication screen 1600 may display a listing of notifications from the application, alerting the user to messages received, updates on events joined, and other information.

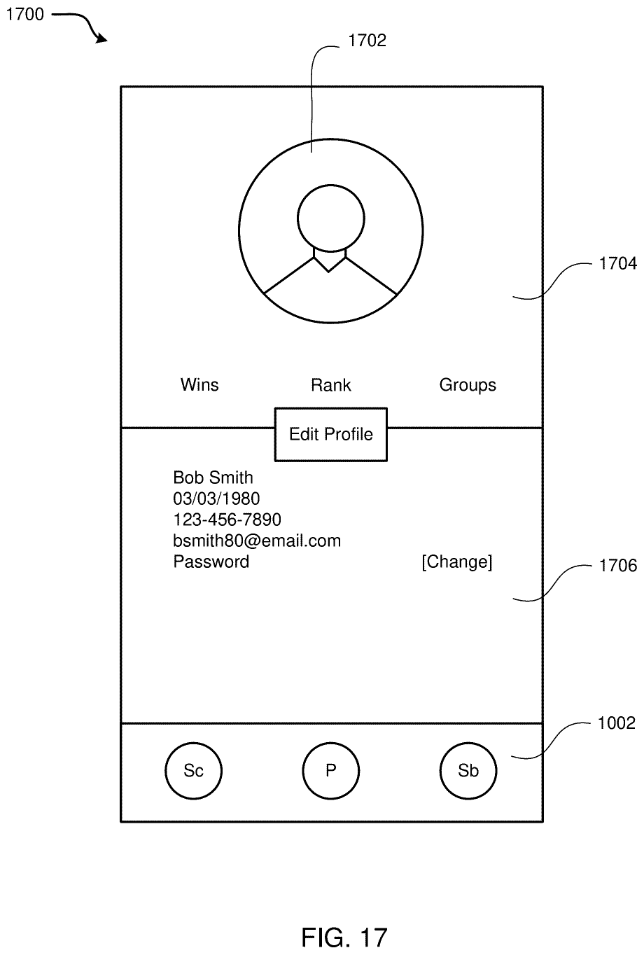

In FIG. 17, profile screen 1700 may show information about a user that a user may enter to personalize a profile on the competing application. Information may include a profile picture 1702, a quick display 1704, and a detailed display 1706. The quick display 1704 may show information like a number of points, wins, groups joined, rank based on points relative to a group, game, or overall, and other information. A user may additionally enter personal information in a detailed display 1706 such as name, telephone number, email, birthday, or other similar information. A user may additionally use the profile screen to update or change a password associated with the user account. From the profile screen a user may additionally access a settings page. The settings page may list a number of configurable options, such as which notifications to receive, font size, picture size, chat size, dark mode, or other user settings.

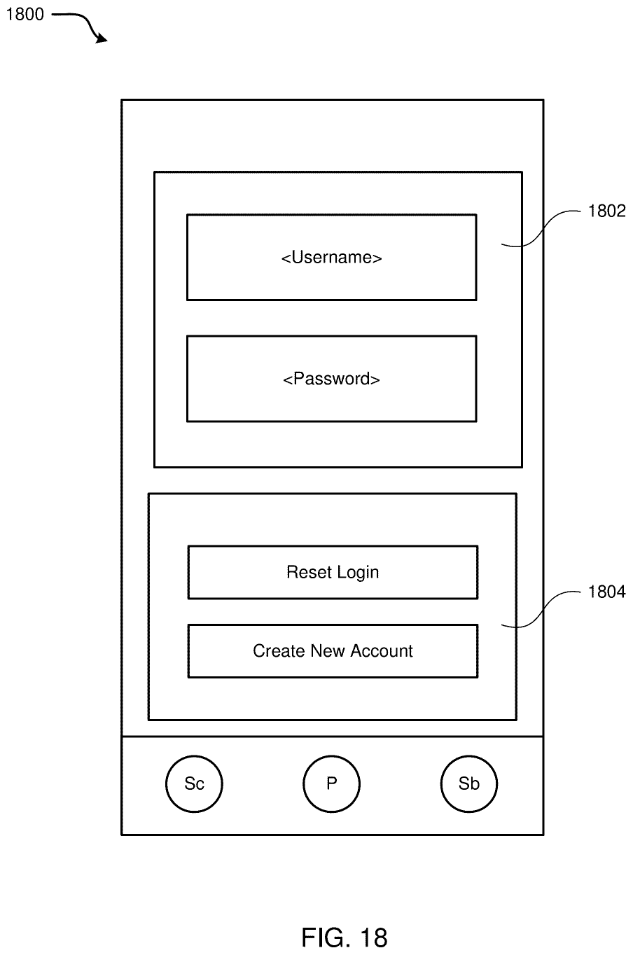

Seen in FIG. 18, the application may feature login screen 1800 where user may input a username and password in login window 1802 in order to access their account within the application. A user may choose to stay signed in or make a requirement to log in every time the app is opened. A user may additionally set a pin or similar shorter password to “lock” the application when the app is not in use or is not accessed for a configurable period of time. A user may use account window 1804 to create a new account or recover an account in instances of a forgotten password or similar issues.

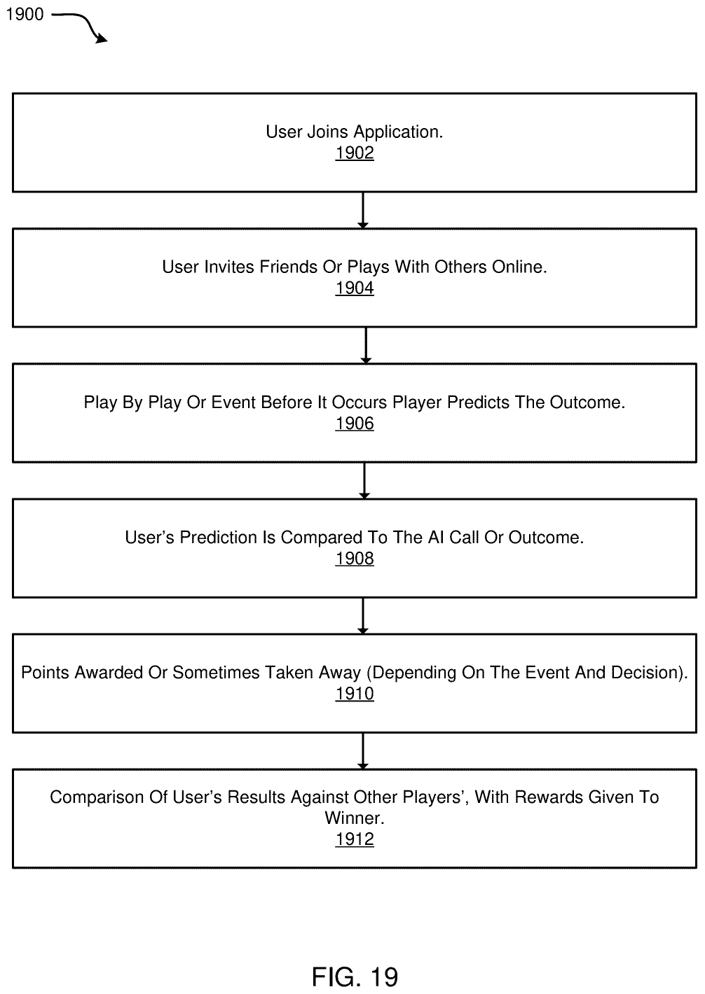

FIG. 19 is a schematic flowchart diagram of a method 1900 for using a predictive competing application. The method 1900 includes a user joining at 1902, and then the user inviting friends or others to join them online at 1904. The method 1900 includes rendering a play-by-play event before it occurs to enable a player to predict the outcome at 1906. The method 1900 includes receiving a user's prediction and comparing the prediction to an actual outcome at 1908. The method 900 includes awarding or taking away point based on event and decision at 1910. The method 1900 includes comparing the user's results against other plays and applying awards to the winner at 1912.

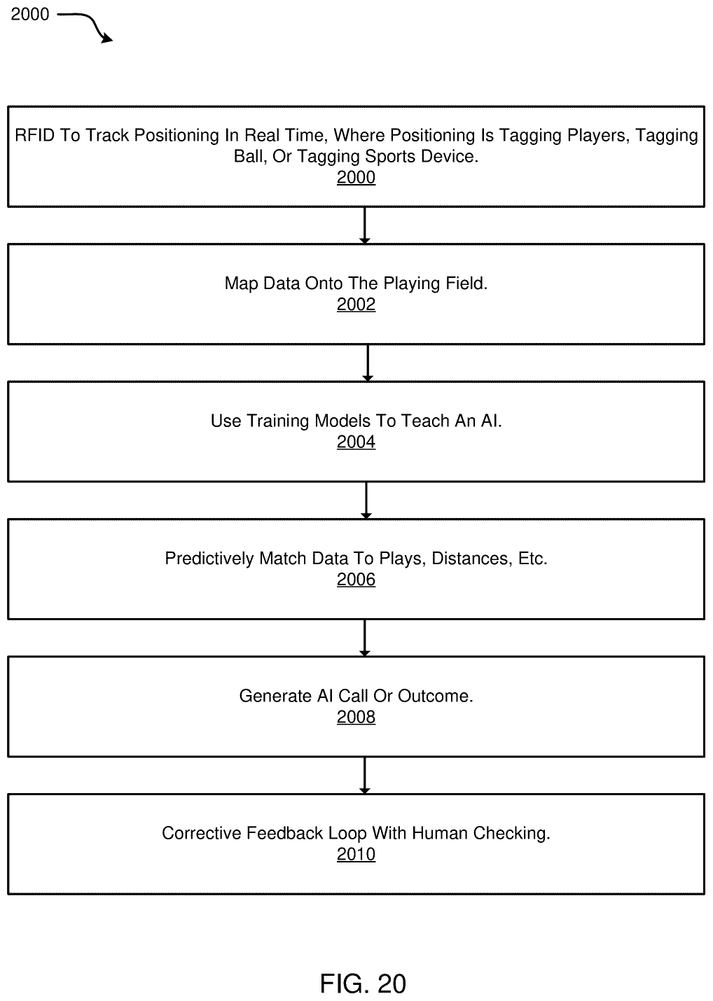

FIG. 20 illustrates a schematic flowchart diagram of a method 2000 for utilizing an AI/ML engine 105 with a predictive competing application. In some implementations, an AI/ML engine 105 may be used with a predictive competing application and the AI/ML engine 105 may be fed information about player positioning, ball positioning, player formation, or other similar information. This data may be mapped in several ways to a playing field or similar to create training models which may be fed to the AI. The AI/ML engine 105 may use analytics to match training data to particular plays, formations, or other decisions to generate an AI-generated decision. This AI-generated decision may be reviewed by a human and corrected if necessary.

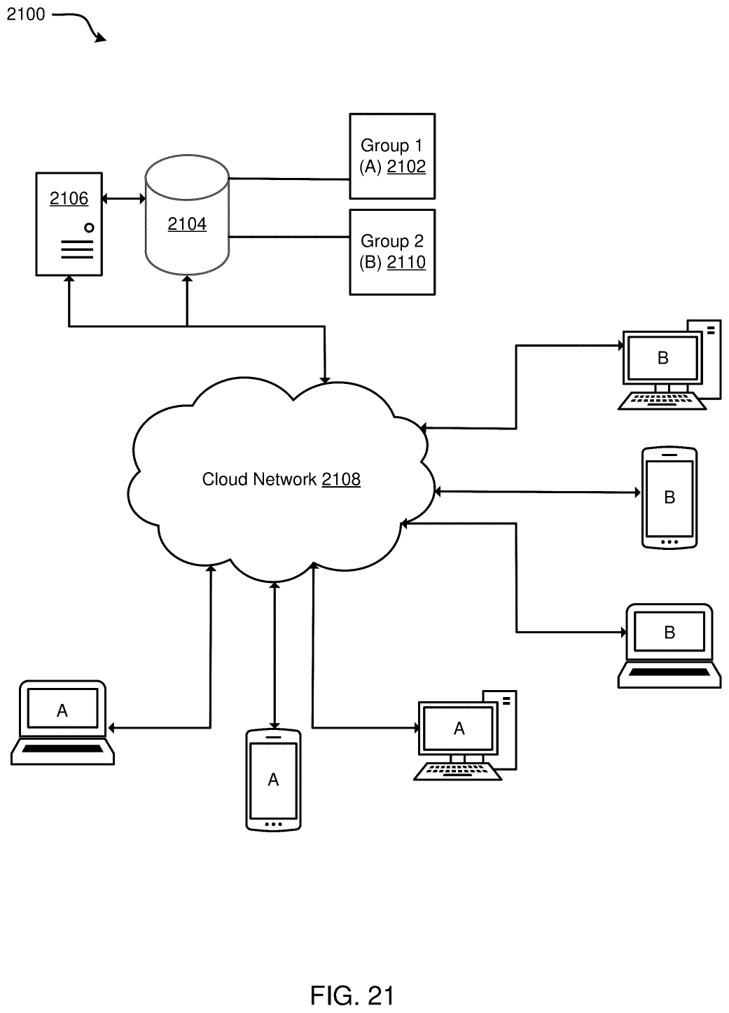

FIG. 21 illustrates multiple groups of computing devices sending and receiving information over a cloud 2108 within the context of a predictive sports competing application according to the principles of the present disclosure. As previously discussed, multiple users may form multiple groups to compete and place bets for a single event, or across multiple events. One or more servers 2106 and databases 2104 may send and receive information over cloud network 2108 to manage multiple groups of players to, for example, keep track of decisions made and points bet during an event. After conclusion of the event, the one or more servers 2106 and databases 2104 will be able to update scores and rankings within groups and leagues for participating users. Shown in the exemplary figure, the devices labeled “A” are joined as Group 1 2102 on database 2104. Devices labeled “B” in the figure are associated as Group 2 2101 on database 2104. While a single database icon is shown in the figure it will be appreciated that other configurations of network hardware and storage are contemplated, and group information may be stored on one or across multiple databases.

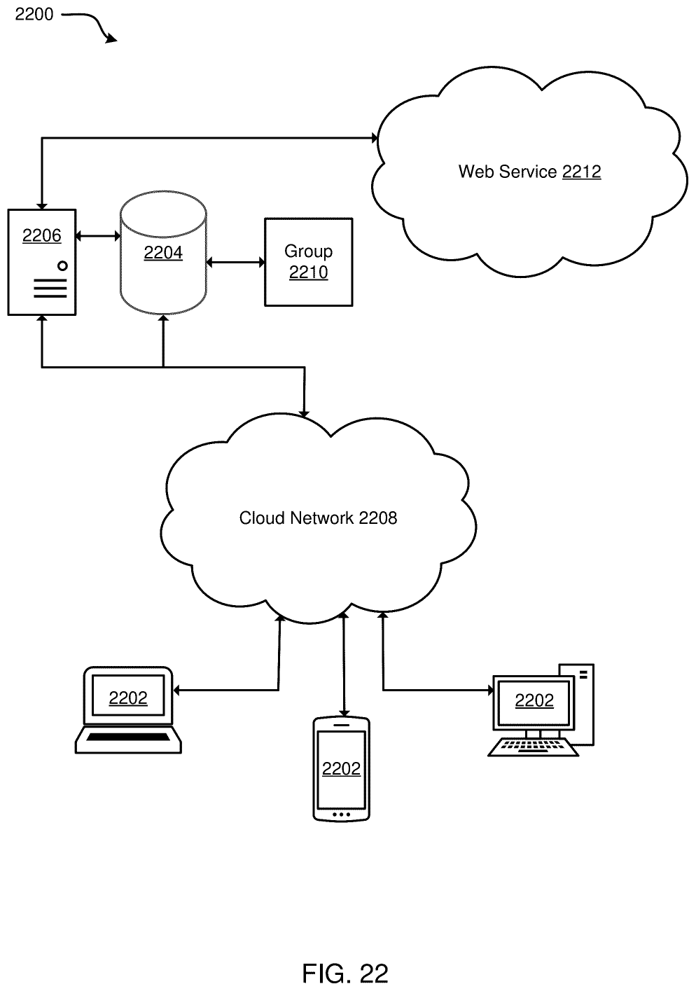

FIG. 22 illustrates a schematic diagram of a system communicating with a web service according to the principles of the present disclosure. During a sporting event, while users are inputting selections, server 2206 may be in communication with a web service owned and operated by a particular sports franchise. For example, web service 2212 may be an Amazon Web Services (AWS) or Microsoft Azure platform owned and operated by the National Football League (NFL). As users 2202 are inputting their selections and uploading their choices over network 2208, server 2206 may be in communication with web service 2212 to receive live telemetry data and updates on calls, decisions, or other information pertaining to the sporting event. By communicating with web service 2212, server 2206 may obtain sporting event information as soon as possible in real time in order to provide feedback to users 2202 and update the predictive competing sports application in real time. In some implementations an Artificial Intelligence, as previously discussed, may be used to ingest, and process the received telemetry data to assist in updating the application.

Due to the nature of sporting events, server 2206 may be constantly sending information back and forth with web service 2212 in order to have the most up-to-date information possible as soon as possible. For example, in a football game, server 2206 may need to update frequently in order to keep pace with the forty second play clock of a football game. As users 2202 make and upload their selections, server 2206 may need to communicate with web service 2212 often enough to be ready to present the next play and official decision as soon as possible after the next play timer starts.

While only one web service 2212 is shown in the figure, it will be appreciated that the system described herein, at scale, may be in communication with multiple web services and multiple users simultaneously in order to provide real time information on a variety of concurrent sporting events to all users.

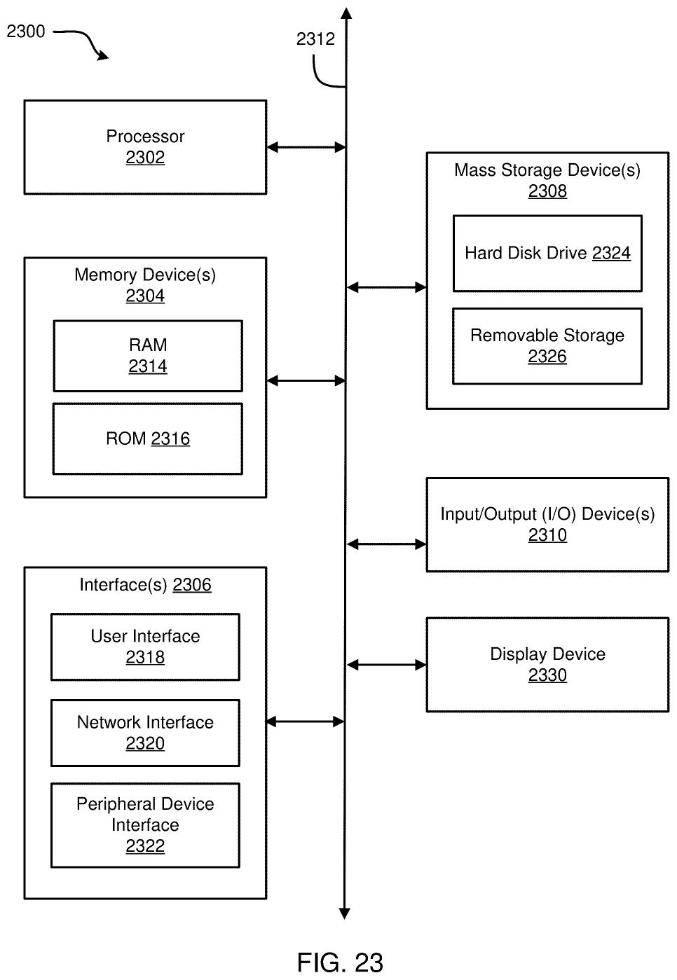

FIG. 23 is a block diagram illustrating an example computing device 2300. Computing device 2300 may be used to perform various procedures, such as those discussed herein. Computing device 2300 can function as a server, a user, or any other computing entity. Computing device 2300 can perform various monitoring functions as discussed herein, and can execute one or more application programs, such as the application programs described herein. Computing device 2300 can be any of a wide variety of computing devices, such as a desktop computer, a notebook computer, a server computer, a handheld computer, camera control unit, tablet computer and the like.

Computing device 2300 includes one or more processor(s) 2302, one or more memory device(s) 2304, one or more interface(s) 2306, one or more mass storage device(s) 2308, one or more Input/Output (I/O) device(s) 2310, and a display device 2330 all of which are coupled to a bus 2312. Processor(s) 2302 include one or more processors or controllers that execute instructions stored in memory device(s) 2304 and/or mass storage device(s) 2308. Processor(s) 2302 may also include various types of computer readable media, such as cache memory.

Memory device(s) 2304 include various computer readable media, such as volatile memory (e.g., random access memory (RAM) 2314) and/or nonvolatile memory (e.g., read-only memory (ROM) 2316). Memory device(s) 2304 may also include rewritable ROM, such as Flash memory.

Mass storage device(s) 2308 include various computer readable media, such as magnetic tapes, magnetic disks, optical disks, solid-state memory (e.g., Flash memory), and so forth. Various drives may also be included in mass storage device(s) 2308 to enable reading from and/or writing to the various computer readable media. Mass storage device(s) 2308 include removable media 2326 and/or non-removable media.

I/O device(s) 2310 include various devices that allow data and/or other information to be input to or retrieved from computing device 2300. Example I/O device(s) 2310 include digital imaging devices, electromagnetic sensors and emitters, cursor control devices, keyboards, keypads, microphones, monitors or other display devices, speakers, printers, network interface cards, modems, lenses, CCDs, or other image capture devices, and the like.

Display device 2330 includes any type of device capable of displaying information to one or more users of computing device 2300. Examples of display device 2330 include a monitor, display terminal, video projection device, and the like.

Interface(s) 2306 include various interfaces that allow computing device 2300 to interact with other systems, devices, or computing environments. Example interface(s) 2306 may include any number of different network interfaces 2320, such as interfaces to local area networks (LANs), wide area networks (WANs), wireless networks, and the Internet. Other interface(s) include user interface 2318 and peripheral device interface 2322. The interface(s) 2306 may also include one or more user interface elements 2318. The interface(s) 2306 may also include one or more peripheral interfaces such as interfaces for printers, pointing devices (mice, track pad, and so forth), keyboards, and the like.

Bus 2312 allows processor(s) 2302, memory device(s) 2304, interface(s) 2306, mass storage device(s) 2308, and I/O device(s) 2310 to communicate with one another, as well as other devices or components coupled to bus 2312. Bus 2312 represents one or more of several types of bus structures, such as a system bus, PCI bus, IEEE bus, USB bus, and so forth.

### Examples

The following examples pertain to further embodiments.

Example 1 is a method. The method includes ingesting sports sensor data in real-time, wherein the sports sensor data is captured at a live sporting event. The method includes rendering a graphical user interface to provide a depiction of at least a portion of the sports sensor data in real-time as the live sporting event occurs. The method includes receiving a plurality of sports play predictions from a plurality of users, wherein each of the plurality of sports play predictions comprises a prediction of an upcoming sports play in the live sporting event. The method includes processing the plurality of sports play predictions prior to the upcoming sports play occurring in the live sporting event. The method includes in response to the upcoming sports play occurring in the live sporting event, evaluating the plurality of sports play predictions against an actual sports play that occurred in the live sporting event to identify which of the plurality of sports play predictions correctly predicted the actual sports play.

Example 2 is a method as in Example 1, further comprising assessing the sports sensor data to calculate one or more predicted upcoming sports plays to occur at the live sporting event; wherein at least a portion of the plurality of sports play predictions comprises a selection of one of the one or more predicted upcoming sports plays.

Example 3 is a method as in any of Examples 1-2, further comprising receiving a plurality of input wagers from the plurality of users, wherein each of the plurality of input wagers is associated with one user and one of the plurality of sports play predictions.

Example 4 is a method as in any of Examples 1-3, further comprising processing the sports sensor data with a neural network trained to predict one or more predicted upcoming plays based on the sports sensor data.

Example 5 is a method as in any of Examples 1-4, wherein the neural network is trained on a plurality of prior plays and prior sensor data associated with the plurality of prior plays.

Example 6 is a method as in any of Examples 1-5, further comprising calculating a minimum wager for each of the one or more predicted upcoming plays, wherein the minimum wager is a minimum value required to be provided by a user for the user to wager that one of the one or more predicted upcoming plays will occur in the live sporting event.

Example 7 is a method as in any of Examples 1-6, wherein calculating the minimum wager comprises: determining an historical frequency for a play option of the one or more predicted upcoming plays; determining a current time in the live sporting event relative to a length of the live sporting event; and determining an historical likelihood for the play option of the one or more predicted upcoming plays to occur at the current time in the live sporting event.

Example 8 is a method as in any of Examples 1-7, wherein the sports sensor data comprises data output by one or more of a location sensor or an inertial measurement unit (IMU) sensor attached to a sports player engaging in the live sporting event.

Example 9 is a method as in any of Examples 1-8, wherein the sports sensor data comprises data output by one or more of a location sensor or an inertial measurement unit (IMU) sensor attached to a ball or tool utilized during the live sporting event.

Example 10 is a method as in any of Examples 1-9, wherein the sports sensor data comprises data output by one or more of a global positioning system (GPS) sensor, an inertial measurement unit (IMU) sensor, a biosensor, a radio-frequency identification (RFID) sensor, an ultra-wideband (UWB) sensor, or a multi-electromechanical systems (MEMS) sensor.

Example 11 is a method as in any of Examples 1-10, further comprising processing the sports sensor data with an artificial intelligence and/or machine learning (AI/ML) engine comprising a large language model (LLM), wherein the AI/ML engine outputs a plaintext explanation of a sports play that occurred at the live sporting event.

Example 12 is a method as in any of Examples 1-11, wherein rendering the graphical user interface comprises displaying the plaintext explanation of the sport play that occurred at the live sporting event.

Example 13 is a method as in any of Examples 1-12, wherein rendering the graphical user interface comprises rendering a graphic indicating a field position of one or more of a ball utilized in the live sporting event or a player engaging in the live sporting event.

Example 14 is a method as in any of Examples 1-13, wherein rendering the graphical user interface comprises rendering a notification regarding the live sporting event, and wherein the notification indicates one or more of: a referee call during the live sporting event; a player substitution during the live sporting event; a player injury during the live sporting event; or a scoring event during the live sporting event.

Example 15 is a method as in any of Examples 1-14, further comprising ranking the plurality of users based on correctly or incorrectly predicting the upcoming sports play, and further based correctly or incorrectly predicting previous sports plays in the live sporting event and in other sporting events.

Example 16 is a method as in any of Examples 1-15, further comprising: generating a prediction group comprising a portion of the plurality of users; receiving preferences for the prediction group; and providing a plurality of prediction options for each play in the live sporting event according to the preferences for the prediction group.

Example 17 is a method as in any of Examples 1-16, further comprising: generating a prediction group comprising a portion of the plurality of users; and pushing data updates to accounts associated with the prediction group in a synchronous manner to ensure all accounts within the prediction group receive the data updates simultaneously.

Example 18 is a method as in any of Examples 1-17, further comprising receiving an input indicating a viewing method for all accounts within the prediction group, wherein the viewing method comprises one of viewing the live sporting event in-person, viewing the live sporting event on broadcast television, viewing the live sporting event on a streaming platform, or listening to the live sporting event on a radio broadcast; and wherein pushing the data updates to the accounts associated with the prediction group comprises synchronizing the data updates with timing of the viewing method.

Example 19 is a method as in any of Examples 1-18, wherein synchronizing the data updates with the timing of the viewing method comprises delaying the data updates relative to other accounts outside the prediction group.

Example 20 is a method as in any of Examples 1-19, further comprising verifying the viewing method of the prediction group based at least in part on a current geographical location of a mobile device associated with the accounts associated with the prediction group.

Example 21 is a system. The system comprises a processor that comprises hardware configured to execute instructions comprising any of the method steps of any of Examples 1-20.

Example 22 is non-transitory computer readable storage medium comprising instructions to be executed by one or more processors, wherein the instructions include any of the method steps of any of Examples 1-20.

Example 23 is a system. The system includes a database; at least one processor configured to communicate with at least one computing device over a network; and a memory comprising software instructions which, when executed by the at least one processor, cause the processor to: retrieve a plurality of events from the database and display the plurality of events to a user; receive, from the user, a selected event; during the selected event, retrieve from the database a plurality of event options in approximately real-time as the event progresses and display the plurality of event options to the user; receive, from the user, a selected event option; receive, from the user, an input wager; evaluate the selected event option by comparing the selected event option to a live result, and adjust a user point value relative to the comparison and the input wager; wherein the live result is received as an approximately real-time update from a server such that the evaluation of the selected event option is also performed in approximately real time.

Example 24 is a system as in Example 23, wherein the user is required to bet a minimum wager for a given event option such that the user is restricted from selecting the given event option when the user point value is lower than the minimum wager.

Example 25 is a system as in any of Examples 23-24, wherein the plurality of event options comprises one or more preview graphics displayed to the user, and wherein the one or more preview graphics comprise one or more of text information describing the plurality of event options or one or more diagrams visualizing the plurality of event options.

Example 26 is a system as in any of Examples 23-25, wherein the event is a sporting event, and wherein the user registers an event and receives one or more notifications about the registered event, wherein the one or more notifications comprises a notification of one or more of: a start of the sporting event, an end of the sporting event, referee calls during the sporting event, substitutions during the sporting event, injuries during the sporting event, or scoring events during the sporting event.

Example 27 is a system as in any of Examples 23-26, wherein the processor adjusts the user point value according to one or more of: the user winning or losing points after evaluation of the selected event option; the user sending points to another user; the user receiving points from another user; or the user purchasing one or more points.

Example 28 is a system as in any of Examples 23-27, wherein the system further comprises an AI/ML engine 105, and wherein the AI/ML engine 105 communicates with the processor to adjust the minimum wager for a given event option according to one or more of: a frequency of occurrence for the given event option, a risk assessment of the given event option, a timing of the given event option relative to a length of the sporting event.

Example 29 is a system as in any of Examples 23-28, wherein the user is ranked against one or more other users relative to a total point value or a net point value, wherein the net point value is determined by a number of points successfully wagered by the user compared to a number of points lost by the user.

Example 30 is a system as in any of Examples 23-29, wherein the processor is further configured to receive input from the user to create a group comprising one or more group users, and wherein the user invites or removes additional users causing the one or more group users to be associated with the group.

Example 31 is a system as in any of Examples 23-30, wherein the processor is further configured to alter the displayed plurality of event options such that the display indicates one or more of the plurality of event options selected by the one or more group users.

Example 32 is a system as in any of Examples 23-31, wherein the processor is further configured to rank the one or more group users within the group according to a point total, and wherein the rank of the one or more group users is adjusted following a conclusion of the sporting event.

Example 33 is a system as in any of Examples 23-32, wherein the processor is further configured to host a plurality of leagues, wherein the user and/or a group comprising one or more users is associated with the one or more leagues, and wherein the user and/or the group are ranked within the league according to a point total.

Example 34 is a system as in any of Examples 23-33, wherein the processor is further configured to: distribute a reward to the user or the group having a highest point total within one of the one or more leagues, and designate the user or the group as a recipient of the reward, such that the reward is visible to other users within the group or within the league.

Example 35 is a system as in any of Examples 23-34, wherein the AI/ML engine 105 receives training data comprising one or more telemetry measurements recorded during one or more prior sporting events and is configured to analyze live data from the sporting event, whereby the AI/ML engine 105 compares the training data to the live data to generate the live result.

Example 36 is a system as in any of Examples 23-35, wherein the user is not required to bet a minimum wager for a given event option such that the user is permitted to select the given event option if the user point value is lower than a minimum wager value.

Example 37 is a system. The system includes a first computing device associated with a first user; a second computing device associated with a second user; a database; at least one processor configured to communicate with the first computing device and the second computing device over a network; and a memory comprising software instructions which, when executed by the at least one processor, cause the processor to: retrieve a plurality of sporting events from the database and display the plurality of sporting events to the first user and to the second user; receive, from the first user, a selected sporting event; during the selected sporting event, retrieve from the database a plurality of event options and display the plurality of event options to the first user via the first computing device, and adjust the display of the plurality of event options according to a relationship between the first user and the second user; receive, from the first user, a first user selected event option; receive, from the first user, a first user input wager; evaluate the first user selected event option by comparing the first user selected event option to a live result, and adjust a first user point value relative to the comparison and the first user input wager.

Example 38 is a system as in Example 37, wherein the processor is further configured to: receive, from the second user, a second user selected event option; receive, from the second user, a second user input wager; and evaluate the second user selected event option by comparing the second user selected event option to a live result, and adjust a second user point value relative to the comparison and the second user input wager.

Example 39 is a system as in any of Examples 37-38, wherein the relationship between the first user and the second user comprises a group, and wherein the display of the plurality of event options is adjusted such that the first user selected event option is visible to the second user via the second computing device, and the second user selected event option is visible to the first user via the first computing device.

Example 40 is a system as in any of Examples 37-39, wherein the relationship between the first user and the second user comprises a league, and wherein the display of the plurality of event options is not adjusted such that the first user selected event option is not visible to the second user via the second computing device, and the second user selected event option is not visible to the first user via the first computing device.

Example 41 is a system as in any of Examples 37-40, wherein the first user and the second user are ranked within a group or within a league according to a comparison between the first user point value and a second user point value.

Example 42 is a system as in any of Examples 37-41, wherein the processor is further configured to: upon input from the first user, send a first number of points from the first user to the second user; and/or upon input from the second user, send a second number of points from the second user to the first user.

For purposes of illustration, programs and other executable program components are shown herein as discrete blocks, although it is understood that such programs and components may reside at various times in different storage components of computing device 1600 and are executed by processor(s) 2002. Alternatively, the systems and procedures described herein can be implemented in hardware, or a combination of hardware, software, and/or firmware. For example, one or more application specific integrated circuits (ASICs) or field programmable gate arrays (FPGAs) can be programmed to conduct one or more of the systems and procedures described herein.

While the functionality of the present disclosure is discussed herein in the context of traditional ball sports, it should be noted that the application of the present disclosure may be altered to accommodate other types of competing and betting in other contexts outside of such sports. For example, the present application could be altered to accommodate a televised auction whereby users could apply or bet points on a selling value of items for sale. In another example, the application of the present disclosure could be configured to accommodate competing on outcomes of political elections. Those skilled in the art will appreciate the flexibility in adapting the present application to other competitive contexts.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

1. A method comprising:
ingesting sports sensor data in real-time, wherein the sports sensor data is captured at a live sporting event;
rendering a graphical user interface to provide a depiction of at least a portion of the sports sensor data in real-time as the live sporting event occurs;
receiving a plurality of sports play predictions from a plurality of users, wherein each of the plurality of sports play predictions comprises a prediction of an upcoming sports play in the live sporting event;
processing the plurality of sports play predictions prior to the upcoming sports play occurring in the live sporting event; and
in response to the upcoming sports play occurring in the live sporting event, evaluating the plurality of sports play predictions against an actual sports play that occurred in the live sporting event to identify which of the plurality of sports play predictions correctly predicted the actual sports play.

2. The method of claim 1, further comprising assessing the sports sensor data to calculate one or more predicted upcoming sports plays to occur at the live sporting event;
wherein at least a portion of the plurality of sports play predictions comprises a selection of one of the one or more predicted upcoming sports plays.

3. The method of claim 1, further comprising receiving a plurality of input wagers from the plurality of users, wherein each of the plurality of input wagers is associated with one user and one of the plurality of sports play predictions.

4. The method of claim 1, further comprising processing the sports sensor data with a neural network trained to predict one or more predicted upcoming plays based on the sports sensor data.

5. The method of claim 4, wherein the neural network is trained on a plurality of prior plays and prior sensor data associated with the plurality of prior plays.

6. The method of claim 4, further comprising calculating a minimum wager for each of the one or more predicted upcoming plays, wherein the minimum wager is a minimum value required to be provided by a user for the user to wager that one of the one or more predicted upcoming plays will occur in the live sporting event.

7. The method of claim 6, wherein calculating the minimum wager comprises:
determining an historical frequency for a play option of the one or more predicted upcoming plays;
determining a current time in the live sporting event relative to a length of the live sporting event; and
determining an historical likelihood for the play option of the one or more predicted upcoming plays to occur at the current time in the live sporting event.

8. The method of claim 1, wherein the sports sensor data comprises data output by one or more of a location sensor or an inertial measurement unit (IMU) sensor attached to a sports player engaging in the live sporting event.

9. The method of claim 1, wherein the sports sensor data comprises data output by one or more of a location sensor or an inertial measurement unit (IMU) sensor attached to a ball or tool utilized during the live sporting event.

10. The method of claim 1, wherein the sports sensor data comprises data output by one or more of a global positioning system (GPS) sensor, an inertial measurement unit (IMU) sensor, a biosensor, a radio-frequency identification (RFID) sensor, an ultra-wideband (UWB) sensor, or a multi-electromechanical systems (MEMS) sensor.

11. The method of claim 1, further comprising processing the sports sensor data with an artificial intelligence and/or machine learning (AI/ML) engine comprising a large language model (LLM), wherein the AI/ML engine outputs a plaintext explanation of a sports play that occurred at the live sporting event.

12. The method of claim 11, wherein rendering the graphical user interface comprises displaying the plaintext explanation of the sport play that occurred at the live sporting event.

13. The method of claim 1, wherein rendering the graphical user interface comprises rendering a graphic indicating a field position of one or more of a ball utilized in the live sporting event or a player engaging in the live sporting event.

14. The method of claim 1, wherein rendering the graphical user interface comprises rendering a notification regarding the live sporting event, and wherein the notification indicates one or more of:
a referee call during the live sporting event;
a player substitution during the live sporting event;
a player injury during the live sporting event; or
a scoring event during the live sporting event.

15. The method of claim 1, further comprising ranking the plurality of users based on correctly or incorrectly predicting the upcoming sports play, and further based correctly or incorrectly predicting previous sports plays in the live sporting event and in other sporting events.

16. The method of claim 1, further comprising:
generating a prediction group comprising a portion of the plurality of users;
receiving preferences for the prediction group; and
providing a plurality of prediction options for each play in the live sporting event according to the preferences for the prediction group.

17. The method of claim 1, further comprising:
generating a prediction group comprising a portion of the plurality of users;
pushing data updates to accounts associated with the prediction group in a synchronous manner to ensure all accounts within the prediction group receive the data updates simultaneously.

18. The method of claim 17, further comprising receiving an input indicating a viewing method for all accounts within the prediction group, wherein the viewing method comprises one of viewing the live sporting event in-person, viewing the live sporting event on broadcast television, viewing the live sporting event on a streaming platform, or listening to the live sporting event on a radio broadcast; and
wherein pushing the data updates to the accounts associated with the prediction group comprises synchronizing the data updates with timing of the viewing method.

19. The method of claim 18, wherein synchronizing the data updates with the timing of the viewing method comprises delaying the data updates relative to other accounts outside the prediction group.

20. The method of claim 18, further comprising verifying the viewing method of the prediction group based at least in part on a current geographical location of a mobile device associated with the accounts associated with the prediction group.
